(19) United States
(12) Patent Application Publication
(10) Pub. No.: US 2012/0321279 A1
(43) Pub. Date: Dec. 20, 2012

(54) METHOD AND APPARATUS FOR PROVIDING AN INTERACTIVE AND OR ELECTRONIC PROGRAMMING GUIDE

(75) Inventor: Ronald Quan, Cupertino, CA (US)

(73) Assignee: Rovi Technologies Corporation

(21) Appl. No.: 13/161,293

(22) Filed: Jun. 15, 2011

(51) Int. Cl. H04N 9/80; H04N 5/445

(52) U.S. Cl. 386/239; 725/39; 386/E05.003

(57) ABSTRACT

An interactive or electronic programming guide is provided, wherein a receiving device such as a DVD or Blu-Ray player, PVR, recorder, set top box, etc., receives data or video signals as well as a trigger, flag or bit pattern signal. A processing and or encoding circuit provides programming, enabling, or disabling of a content control signal in response to the trigger, flag, or bit pattern signal and the content control signal is combined with the video signal to provide a content controlled video signal which provides resistance to a circumvention device (e.g., a “black box”).

### CROSS-REFERENCE TO RELATED APPLICATION

This application claims priority to U.S. application Ser. No. 12/882,474, filed Sep. 15, 2010, which claims benefit of U.S. Provisional Ser. No. 61/249,394, filed Oct. 7, 2009, which are incorporated herein by reference in their entirety.

### BACKGROUND

The present invention pertains to video recorders or personal video recorders (PVRs) and more particularly to a method and apparatus for receiving data, IPG and or EPG signals, providing an IPG and or EPG display and providing a content controlled video signal which provides resistance to a circumvention device.

Previous video recorders require a tuner/demodulator to record a video program. Ergo, to record multiple video programs, multiple tuners are coupled to an RF signal, wherein each tuner is set to a particular frequency or channel. The output of each tuner, which includes demodulation of each channel, is then coupled to a recorder for recording and subsequent playback.

In an advanced television system committee (ATSC) format, one channel may contain up to 4 to 15 sub channels, which then requires up to 4 to 15 tuners for demodulation of the sub channels contained in that the one ATSC channel. Thus, there is a need to more efficiently record video and or audio information, from for example, a digital television (DTV) stream.

### SUMMARY

Accordingly, the present invention provides various embodiments for providing an interactive programming guide (IPG), and or electronic programming guide (EPG), including, for example; a receiving device including a circuit for receiving a metadata, IPG, and or EPG signal from a digital delivery network, wherein the digital delivery network provides the receiving device with a trigger, flag or bit pattern signal; a processing circuit and or encoding circuit for providing programming, enabling, or disabling of a content control signal at an output of the processing and or encoding circuit in response to the trigger, flag, and or bit pattern signal; and wherein the content control signal is added to or inserted in a video signal to provide a content controlled video signal which provides resistance to a circumvention device.

Another embodiment of the invention provides an electronic programming guide (EPG) or interactive programming guide (IPG) via a system operator or a broadcaster, including for example; sending or distributing data or signals related to the electronic programming guide or interactive programming guide to a receiving device via a system operator or broadcaster; sending or distributing a bit pattern or one or more control bits related to content control to the receiving device via the system operator or broadcaster; wherein the receiving device provides a video signal for display as the electronic programming guide or interactive programming guide; and wherein the receiving device provides the video signal with a content control signal to provide a content controlled video signal which provides resistance to a circumvention device.

Other embodiments circumvent or reduce or eliminate the need for a multiplicity of tuners and demodulators when recording and playing back multiple video programs.

One embodiment records the broad spectrum of a television signal into a storage device. Upon playback, the storage device acts as a “delayed” broadcast RF signal such that the signal of any of the channels (including any sub channel) may be tuned and demodulated and viewed or distributed.

For example, a broad spectrum of television signals from 1 MHz to 19 MHz may represent three 6 MHz bandwidth digital television (DTV) channels (ATSC, SDTV, and HDTV channels). Depending on the compression ratio, up to 3 or 4 SDTV (sub digital television) channels fit into the 6 MHz channel space. Thus, three HDTV (high definition television) channels may be recorded simultaneously or up to 12 SDTV sub channels instead, or some combination of numbers of HDTV and SDTV channels or sub channels, which were recorded simultaneously when recording the signal from 1 MHz to 19 MHz. In a simplest form, a single 6 MHz RF channel is recorded in the storage device to allow playback from the storage device to a tuner to extract multiple SDTV channels or sub channels, or some combination of SDTV channels and an HDTV channel. Note that channels or sub channels may include one or more audio and or video channels.

An alternative embodiment receives a broadband television signal and mixes or translates the multiple channels into a frequency range, which then is converted from an analog signal to a digital or discrete time signal for storage. The storage device is controlled by record commands and plays back a digital representation of the analog RF broadband signal. A digital to analog converter converts the output of the storage device to an analog RF signal, which then can be coupled to one or more tuners to view or distribute the one or more programs existing in the recorded RF signal.

One embodiment provides an alternative or improved method of recording audio and or video programming over the method such as disclosed, for example, in U.S. Pat. No. 7,454,120 (the '120 patent), herein incorporated by reference, where multiple tuners are used in recording more than one video program at a time. For example, an improved method of recording audio and or video programs (e.g., via a personal video recorder or PVR) includes one or more tuners/demodulators to record one or more programs at a time, but also includes a capability to record a broadband radio frequency signal. This improved method allows playing back a particular video program that has been demodulated, and or playing back (e.g., via a tuner) a video program from the radio frequency domain.

Another embodiment also includes features disclosed in the PVR system of the '120 patent, and, in addition, includes processes which provide copy protection (e.g. negative going pulses, positive going pulses, and or a phase modulated signal within an overscan area of the television field) or digital rights management (DRM). For example, a PVR system including multiple tuners may include a content control signal that provides resistance to certain circumvention devices.

With major advances in low cost high speed analog to digital converters (ADC) and in low cost memory devices, another embodiment provides for recording a broadband, or one or more TV channel(s) or radio channel(s), by digitizing the RF domain signals. Prior to digitization, some form of frequency translation is done for one or more RF channels, which usually reside in the VHF or UHF spectrum. The frequency translation maps these channels to a lower frequency spectrum for more efficient analog to digital conversion and digital recording. It is to be understood that “translating” refers to operating in the frequency domain, to move frequency spectrums up or down in frequency.

Alternatively, since an analog to digital converter (ADC) utilizes a sampling frequency clock, the sampling frequency clock may be used as a method of digitizing an analog input signal and of providing one or more translated spectrums of the analog input signal. Sub-Nyquist sampling of signals provides a frequency translated spectrum of the input to an analog to digital converter. For example, if the (equivalent) sampling frequency of the analog to digital converter is less than twice the bandwidth or highest frequency of the input (RF) signal, then frequency translation is provided by the analog to digital converter, for example, in a form of alias signal(s). Thus, in an alternative embodiment, a radio frequency signal (e.g., ATSC or HDTV RF signal) may be coupled to an analog to digital converter, with or without a translation element or module prior to the input of the analog to digital converter.

As shown in relation to block 61 of FIG. 6, an output of any of the embodiments of previous description, may include content control signals (e.g., data, CGMS, flag signals) and or at least part of a copy protection signal such as modified color burst envelope, automatic gain control (AGC) pulses, pseudo sync pulses, narrowed horizontal syncs, incorrect phase or frequency in terms of color subcarrier frequency provided in a horizontal blanking interval or its vicinity, level shifted portion of a video signal, and or modified sync or AGC pulses in amplitude, position, and or duration.

The following patents pertaining to copy protection, content control, or flag signals are incorporated by reference: U.S. Pat. Nos. 4,631,603 (e.g., signal including pseudo sync and or AGC pulses); 4,819,098 (e.g., signal including AGC back porch pulses and or horizontal sync amplitude modification/modulation); 4,577,216 (e.g., signal including phase modulated color burst); 5,130,810 (e.g., signal including back porch pulse, positive and or negative); 5,315,448 (e.g., control bit pattern for adding/inserting content control signal); 4,937,679 (e.g., detection of negative and or positive going pulses for content control); 4,907,093 (e.g., detection of negative and or positive going pulses for disabling or modifying recording); 5,583,936 (e.g., lowered back porch signal); 6,381,747 (e.g., providing content control via a control bit(s) from a digital delivery system to a receiver wherein the receiver provides a content control signal at its output); 6,836,132 (e.g., color stripe or split burst color stripe signal for content control); 6,836,549 (e.g., position and or pulse width modulation of negative and or positive pulses that are utilized for a content control system); 7,039,294 (e.g., color burst modification for content control); 7,050,698 (e.g., lowered front and or back porch with color burst modification); 7,085,380 (e.g., adding/inserting a negative going pulse to a video signal as part of a content control signal); 6,501,842 (e.g., adding a negative going pulse in a back porch region as part of a content control signal for a video signal); 7,492,896 (e.g., lowered back porch in a video signal); 6,600,873 (e.g., detection of phase modulated color burst such as color stripe or split burst color stripe signal for content control).

Thus, an output of any embodiment of previous description may include a weakened color stripe signal, and or a copy protection signal, that provides resistance to a circumvention device, generally known in the industry as a “black box.” A weakened color stripe signal is generally used for content control while providing excellent playability of the copy protected video signal on a television set.

In another embodiment, one or more ATSC channel and or radio channel is translated to a lower frequency spectrum. An analog to digital converter (ADC) converts the lower frequency analog signal RF into a digital signal for subsequent storage. It should be noted that after digitization from the ADC, coding or compression techniques and or transformations may be applied to save on storage space. Upon playback from the storage device, which may include decoding or decompression schemes or transformations, a digital to analog converter reproduces an RF signal. A tuner then is utilized to provide multiple program signals from the recorded ATSC channel(s).

In yet another embodiment, an RF signal is supplied to a recorder to store or record the RF signal. The recorder then plays back a recording of the RF signal to a tuner and or demodulator for subsequent display and or signal distribution. Thus, it is to be understood that translation functions or circuits, intermediate frequency (IF) systems, and or mixers may be optional, such that an RF signal is coupled to a recorder without frequency translation and or intermediate frequency circuits or systems. An example of such a RF signal is a signal including video, text, and or audio information. Another example of such a RF signal is a signal which includes an FM (frequency modulated), PM (phase modulated), and or AM (amplitude modulated) signal. Other examples of the RF signal include a DTV signal, an analog RF television signal, an HDTV RF signal, a modulated signal, a sub channel video, a WiFi signal, a WiMax signal, an Internet signal, a wireless network signal, a LAN (local area network) signal, an 802.11 signal, an Ethernet signal, a Mobile (e.g., analog and or digital) TV signal, a Handheld (e.g., analog or digital) TV signal, a sub channel audio, video channel, audio channel, and or data signal/channel. Any of the RF signals may be coupled to a recorder (with or without a frequency translation circuit/system and or an intermediate frequency system) for recording in the RF domain. Any of the recorded signals may then be coupled to a demodulator or tuner for providing one or more video, audio, and data signal/channel.

An embodiment may include the ability to record one or more channels from the RF domain of a transmitted signal (e.g., off the air such as a television/radio signal), a cable television/radio signal, a satellite television/radio signal, an Internet, WiFi, Wimax, cell phone RF signal, and or the like. Further, an embodiment includes playing back a recorded signal from the RF domain such as, for example, play back of a recorded signal including vestigial sideband, phase/amplitude modulated, quadrature modulated, and or frequency modulated signal, and coupling (via playback) the recorded (RF) signal to a tuner/demodulator to provide a signal for displaying/viewing (video) and or listening (audio). One or more tuners and or demodulators may be coupled to the playback of the recorded RF signal to provide one or more selection (or simultaneous selection) of (demodulated) video, data, metadata, and or audio signals.

In yet another embodiment, an optical signal may be coupled to a recorder for recording in optical format as an optical signal (e.g., modulated waveform). An output of the recorder may include an optical and or electrical output for display, transmission, and or distribution.

In still another embodiment, during or prior to recording, one or more ATSC channels, RF channels, or radio channels may be sensed, for example, via a tuner, for use as metadata. This metadata, such as programming schedules or guides, or information, may be stored or displayed to assist a user. Alternatively, the recorder may be coupled to WiFi, WiMax, digital network, IPTV, or linked to a Web (e.g., World Wide Web), which downloads and/or displays pertinent information of the program audio or video selections, or provides content or program material. Thus, an embodiment may include a tuner for a broadcast system and or a tuner for a wireless network.

### BRIEF DESCRIPTION OF THE FIGURES

FIGS. 1A and 1B are block diagrams exemplifying prior art recording devices.

FIGS. 2A and 2B are block diagrams illustrating embodiments described herein.

FIG. 2C illustrates another embodiment.

FIGS. 3A and 3B are waveforms showing examples of frequency translation or mixing.

FIG. 4 is a block diagram illustrating another embodiment.

FIG. 5 illustrates another example of frequency translation.

FIG. 6 is a block diagram illustrating embodiments including a content control signal and or a copy protection signal.

FIGS. 6A-6C are block diagrams illustrating embodiments of the invention.

FIGS. 7A and 7B are block diagrams illustrating further embodiments.

FIGS. 8A and 8B are waveforms illustrating examples of prior art copy protection signals.

FIG. 8C are waveforms of video line locations for a 525 line TV standard such as NTSC.

FIGS. 9A and 9B are waveforms illustrating examples of one or more waveforms for combination with receiving devices of the invention.

FIG. 10A is a block diagram illustrating a prior art circumvention (“black box”) device.

FIG. 10B is a block diagram illustrating a timing circuit including a microprocessor device for a circumvention device.

FIG. 10C is a block diagram illustrating a timing circuit including a retriggerable circuit for a circumvention device.

FIG. 11A illustrates the line locations of two prior art copy protection processes within a portion of the vertical blanking interval (VBI) and active field.

FIG. 11B is a waveform illustrating an output of a first timing circuit of a prior art sync separator and timing circuit.

FIG. 11C is a waveform illustrating a blanking or removing pulse triggered by the trailing edge of the waveform in FIG. 11B.

FIG. 12A illustrates the line locations of copy protection signals for an embodiment (e.g., NEW1).

FIG. 12B is a waveform illustrating a blanking or removing pulse derived from timing circuits 22 or 22″ of FIG. 10A or 10C, respectively.

FIG. 12C is a waveform illustrating a blanking or removing pulse derived from circuit 22′ of FIG. 10B.

FIG. 13A illustrates the line locations of alternative copy protection signals for another embodiment (e.g., NEW2).

FIG. 13B is a waveform illustrating a blanking or removing pulse derived from circuit 22 of FIG. 10A.

FIG. 13C is a waveform illustrating a blanking or removing pulse 12̂ or 12* derived from circuits 22′ or 22″ of FIG. 10B or 10C, respectively.

FIG. 14 is a waveform illustrating a video signal prior to inserting or adding a copy protection signal.

FIG. 15A is a waveform illustrating a video signal with a prior art copy protection signal.

FIG. 15B is a waveform illustrating an effect of a circumvention device on the video signal of FIG. 15A.

FIG. 16A is a waveform illustrating a video signal with a copy protection signal of an embodiment of the invention.

FIG. 16B is a waveform illustrating an effect of a circumvention device on the video signal of FIG. 16A.

FIG. 17 is a block diagram illustrating an embodiment of the invention comprising a processor, which is coupled to a circumvention device and other equipment.

FIGS. 18A-18D illustrate examples of systems or apparatuses for one or more embodiments for implementing the various waveforms of description herein.

FIGS. 19A-19E illustrate examples of a system operator, digital receiving system, and or receiver which, in accordance with the invention, employ the copy protection signals of description herein.

FIGS. 20 and 21A-21C illustrate various embodiments of the invention.

### DETAILED DESCRIPTION

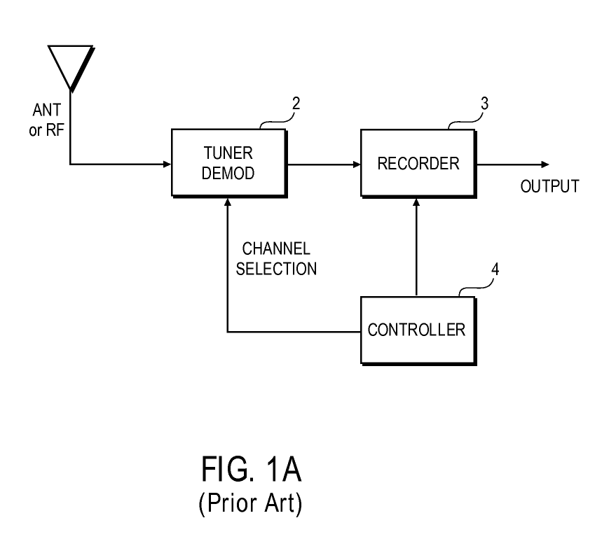

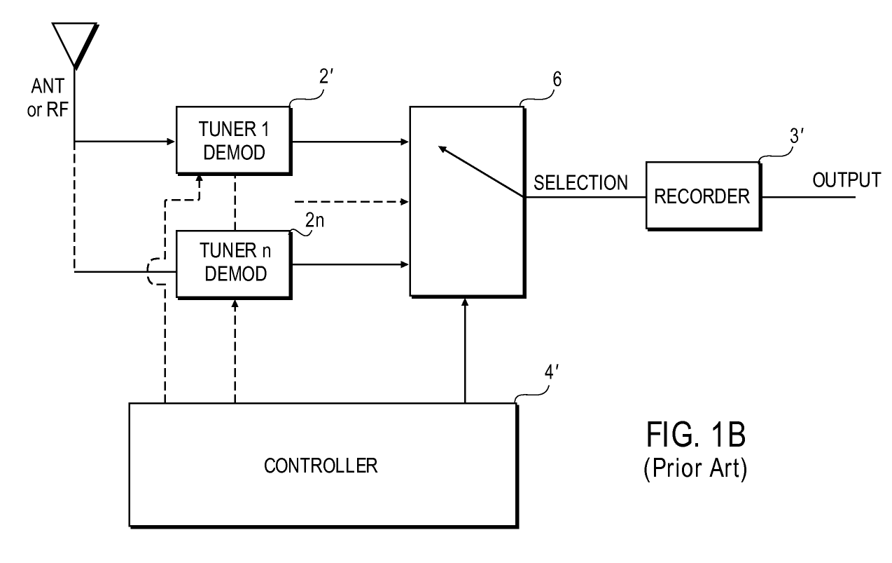

FIG. 1A illustrates a conventional recorder, where an antenna or RF signal (source) is coupled to a tuner-demodulator 2. The tuner-demodulator receives analog and or digital signal transmissions, such as PAL or NTSC video signals for analog systems, or DTV or ATSC signals for digital systems.

The tuner-demodulator 2 in analog systems may comprise an AM detector. The output of the AM detector is an analog signal, which in turn is coupled to a recorder 3, which may include an analog to digital converter to enable digitally recording the analog video signal.

For a digital signal, demodulation is provided by an 8VSB (vestigial sideband modulation) or QAM (quadrature amplitude modulation) detector. The detector output of the 8VSB or QAM demodulated signal is in the form of a transport stream, which requires decompression from formats such as MPEG-1,2, or 4, Divx, Windows Media, RealNetworks, DB-25, H.264, DCT or wavelet coding, or the like.

A controller 4 is provided to set the channel for the tuner-demodulator 2, and or to set the recording times or intervals for recorder 3.

FIG. 1B illustrates an alternative though similar recording system as that in FIG. 1A, and includes multiple tuner-demodulators 2′ through 2n to allow for recording and or viewing multiple channels via the demodulated 8VSB or QAM signals. Here the RF signal is coupled via an antenna or other connection to the tuner-demodulators 2′ through 2n. A selection switch 6 is coupled to the tuner-demodulators 2′ through 2n. It should be noted that switch 6 can switch in more than one source at a time, which allows a recorder 3′ to record one or more transport streams from the demodulated 8VSB or QAM signals. Controller 4′ allows channels to be set on the tuner-demodulators and or allows the switching of one or a combination of channels from respective tuner-demodulator(s) to be coupled into the recorder 3′.

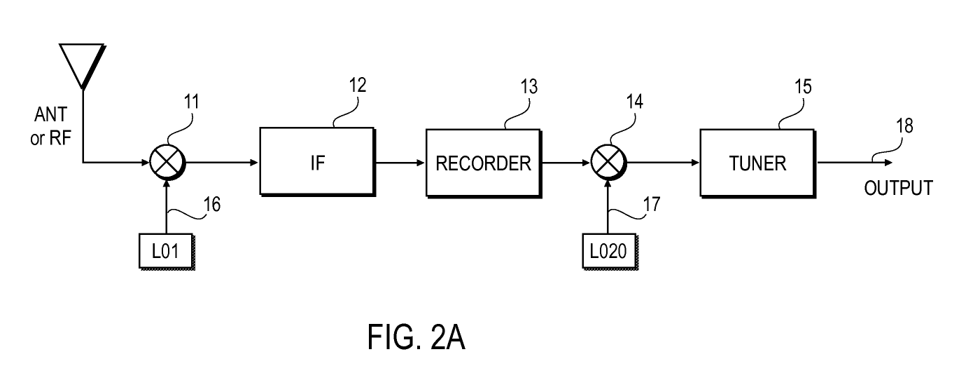

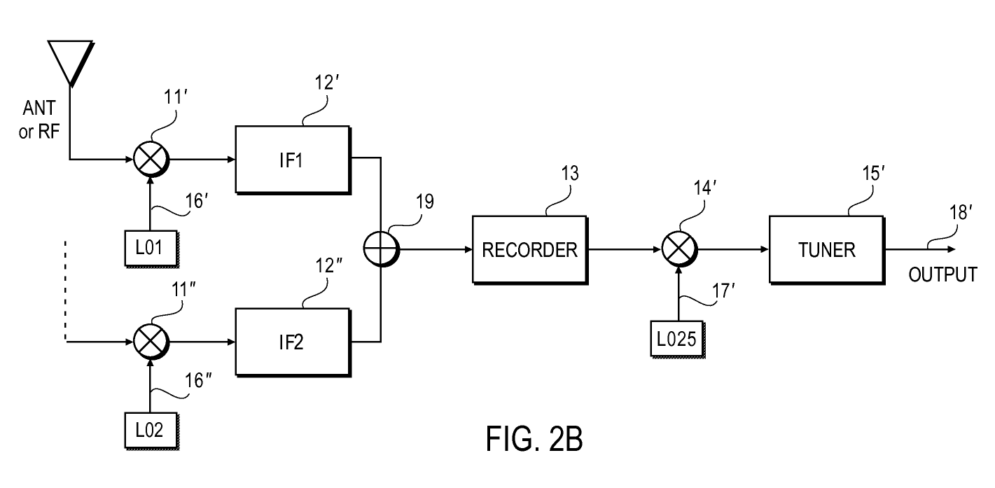

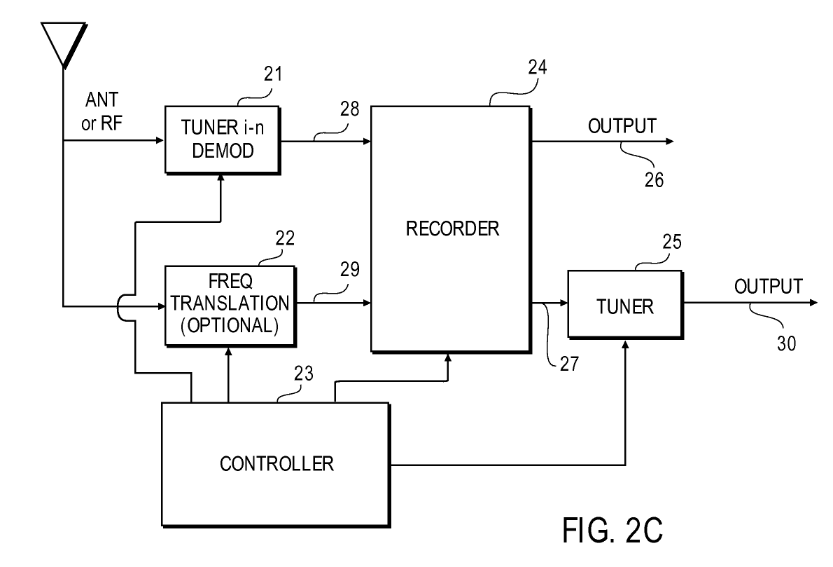

FIG. 2A is a block diagram illustrating an embodiment wherein an RF signal from an antenna is coupled to a first input of a mixer 11, while a second input of mixer 11 is coupled to a local oscillator (LO1) via an input 16. The output of the mixer 11 is coupled to an intermediate frequency (IF) amplifier/filter 12, which provides a frequency translated RF spectrum to a recorder 13. For example, an ATSC channel at a UHF frequency beyond 490 MHz, is mixed down via the mixer 11 to a lower frequency (e.g., less than 10 MHz), or to an intermediate frequency (IF) analog signal, which allows easier analog to digital conversion in the recorder 13.

With recorder 13 recording the RF spectrum such as VSB or QAM signals, playback of the recorded RF spectrum provides VSB or QAM signal(s). The output of recorder 13 is coupled to a tuner 15 via an optional mixer 14. A second input of mixer 14 is coupled to a local oscillator (LO20) via an input 17. Mixer 14, for example, converts or translates the IF signal, for example, from recorder 13 (or amplifier/filter 12) back to an RF channel frequency. It follows that a tuner 15 can demodulate the multiple channels within the RF channel that is selected. It is given that the multiple channels within the RF spectrum were recorded simultaneously. As an example, some ATSC channels include a high definition (HD) channel and one or more sub channels that may include standard definition video and or audio sub channels, while a digital television (DTV) channel may include any combination of HD, SD, and audio channels. Thus by recording substantially the (single) selected RF channel, multiple video and or audio programs may be combined, recorded and then individually or selectively demodulated or recovered.

FIG. 2B is a block diagram illustrating another embodiment for recording multiple RF channels, to provide further channels from different RF channels along with the one or multiple channels demodulated in each RF channel recorded. An antenna or RF signal (source) is coupled to one or several mixers, herein illustrated by mixers 11′ and or 11″. A local oscillator (LO1) provides an input 16′ to the mixer 11′. The local oscillator LO1 is set at a frequency (FLO1) such that the mixer 11′ outputs a frequency spectrum IF1. Similarly, a local oscillator (LO2) provides an input 16″ to the mixer 11″. The local oscillator LO2 is set at a frequency (FLO2) such that the mixer 11″ outputs a frequency spectrum IF2. The outputs of mixers 11′ and 11″ are supplied to IF amplifiers or filters 12′ through 12″, respectively.

The outputs of the amplifiers or filters 12′ and 12″ (of frequency spectrums IF1 and IF2) now contain a signal RF spectrum for two or more RF channels. A combining circuit 19 sums the two RF signals IF1 and IF2 from amplifier/filters 12′ and 12″ and couples its output to a recorder 13. The recorder 13 records an analog signal containing two or more RF channels. Upon playback, the recorder 13 is coupled to a tuner 15′ via a mixer 14′, wherein the tuner 15′ selects the RF channel related to the frequency spectrums IF1 and or IF2. Note that tuner 15′ may include multiple tuners (and or demodulators) to tune each channel related to signals IF1 and or IF2. The mixer 14′ is coupled to a local oscillator (LO25) at an input 17′ to the mixer 14′. The mixer 14′ may be used to translate the recorded and played back IF1 and or IF2 frequency spectrums to channel allocations typically in the VHF or UHF spectrum. The output of the tuner 15′ has an output 18′, which provides the multiple (program) channels demodulated for each RF channel recorded.

Although in a simplest form, the mixer 14′ may translate both the spectrums IF1 and IF2 via the local oscillator (LO25), it is possible to translate each spectrum IF1 and or IF2 to a specified or determined channel frequency by using two mixers and two local oscillator frequencies. It is understood that although FIG. 2B shows an example of two RF channels, N number of channels may be scaled accordingly to record N RF channels. It should be noted in general, an intermediate frequency, IFx=p(Frequency of RF source)+/−q(Frequency of LO, a local oscillator), where x, p, and q are integers.

FIG. 2C shows an embodiment including a RF signal recording, and or a demodulated RF signal recording. An antenna (ANT) or RF signal source is coupled to one or more inputs of one or more tuner-demodulators 21. One or more outputs 28 of the one or more tuner-demodulators is coupled to a recorder 24. The antenna or RF signal source also is coupled to an input of an optional frequency translation module 22, which is implemented by a function and or a circuit. An output of the frequency translation module 22 is coupled via an input 29 to the recorder 24. Note that the frequency translation module 22 may be bypassed whereby the antenna or RF signal is coupled to the recorder 24. Controller 23 configures one or more demodulated channels to be recorded and or one or more RF signals, spectrums or bands to be recorded. An output 26 of recorder 24 comprises a playback signal of one or more demodulated television channel. Recorder 24 may playback an RF signal 27, which is coupled to an input of a tuner 25. An output of tuner 25 provides (via controller 23) a selection of playback of one or more channels and or one or more sub channels. The sub channels may include flexibility to select a secondary audio program (SAP) and or an auxiliary audio/video channel, or access to metadata or programming guides. Thus, for example, output 26 provides a “main” channel viewing, while (simultaneously) an output 30 provides “surfing” on the recorded RF channel(s) and or sub channels.

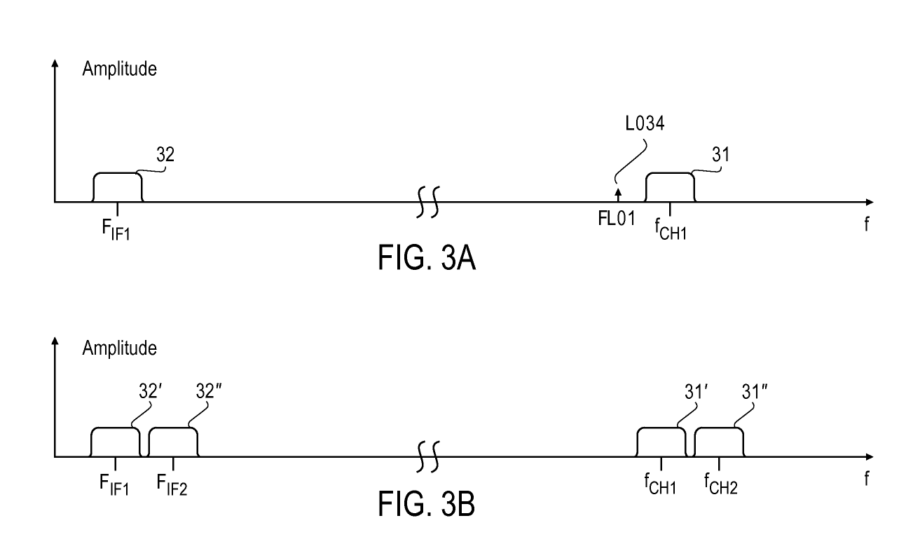

FIG. 3A illustrates an embodiment of RF spectrum translation, As previously mentioned, one or more RF channel is translated down and recorded via an ADC in a storage medium. (See FIGS. 2A and 2B). In this example, frequency fCH1, (waveform 31), represents a typical RF channel in the VHF, UHF, or higher frequency spectrum. For ATSC, this RF channel is about 6 MHz wide, and includes a main program channel plus one or more sub program channels (e.g., a weather channel, a traffic channel, alternate SDTV programming, audio programming such as radio, etc.), plus metadata and or a programming guide(s). A local oscillator LO34 at a frequency FLO1 is set lower (or higher) than the frequency of fCH1 to mix down to a lower frequency FIF1, (waveform 32). For example, the difference frequency provided by a nonlinear element, function or mixer, takes the two higher frequencies fCH1 and FLO1 and provides a lower frequency, absolute value |fCH1−FLO1| for the frequency spectrum FIF1.

In some embodiments, the translated channel FIF1, which as previously mentioned includes a main program channel plus one or more sub program channels, such as a weather channel, a traffic channel, time code, alternate SDTV programming, audio programming such as radio, etc., is converted from an analog RF signal to a digital signal. The digital signal then can be stored in a medium, such as, for example, tape, magnetic disc, optical disc, RAM, ROM, flash memory, electromechanical storage, and or solid state storage device(s).

FIG. 3B illustrates another embodiment wherein more than one RF channel is recorded by frequency translation. For example, RF channels fCH1 (spectrum 31′) and fCH2 (spectrum 31″) are mixed down in frequency by oscillator frequencies FLO1 and FLO2, respectively (not shown), to provide lower frequency RF channels FIF1 (spectrum 32′) and FIF2 (spectrum 32″). These two (or more) lower frequency RF signals are then digitized via an ADC and coupled to a (digital) storage device for recording. Again, frequency spectrums FIF1 and or FIF2 still retain a program video channel, time code, audio, sub-video-channel(s), radio channel(s), metadata, and or programming guide (information).

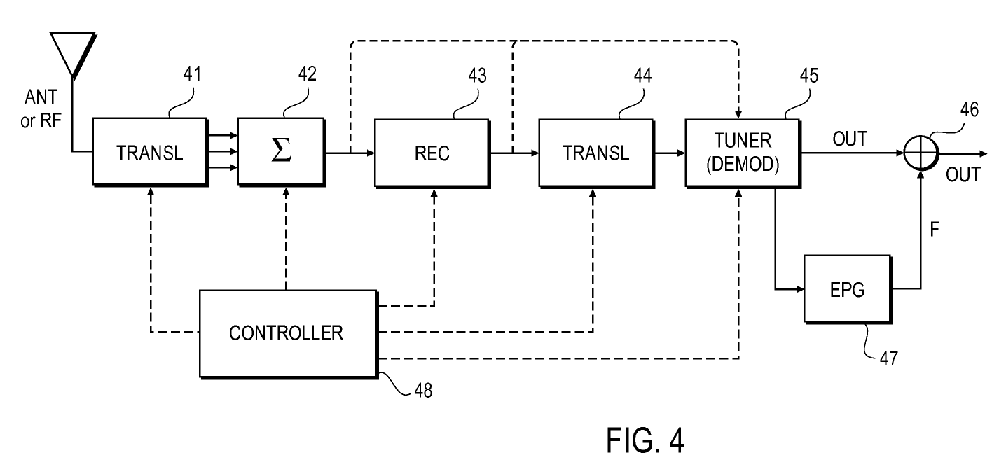

FIG. 4 is a block diagram illustrating another embodiment. An RF signal or signal from an antenna or link (e.g., an optical, phone, cable, satellite, wireless link, etc.) is coupled to a frequency translator 41. The translator 41 outputs one or more frequency translated RF channels to a summer/combiner 42, whose output is then one or more down-converted RF channel, which is coupled to a recorder 43. Recorder 43 typically includes an analog to digital converter to digitize the down-converted RF channel(s) for recording into a digital storage media.

The output of the recorder 43 includes a digital to analog converter (DAC) which outputs one or more frequency translated RF analog signal(s) for one or more channel(s). The output of recorder 43 may be coupled directly to a tuner 45, or may be coupled to the tuner 45 via a frequency translator 44. If the tuner is capable of receiving lower frequency signals, the translator 44 may not be necessary. If the tuner 45 is set for a standard broadcast tuning or higher frequency tuning (e.g., higher than an IF frequency) translator 44 is used in up-converting or translating the IF signal(s) to channels in the VHF, UHF, or higher, frequencies.

The tuner 45 may be coupled to an electronic programming guide (EPG) 47 or to a programming guide device or reader, which extracts metadata and or programming guide information from the tuner 45. A summing device or circuit, summer 46 then provides program video from tuner 45 and or programming guide information from EPG 47, at the output of the summer 46.

A controller 48 provides control signals to translator 41 for translating selected RF channels and to summer/combiner 42 for summing or combining selected IF frequency channels. Controller 48 also may send a command to recorder 43 for recording times, input signals selection, etc. Upon playback, controller 48 allows tuner 45 to select one or more recorded RF channels or subchannels for viewing or for distribution.

It should be understood that the embodiments of FIGS. 2A, 2B, 2C and 4 may be combined with the features or circuits previously mentioned and shown for example in FIG. 1A or 1B. Or in general, any embodiment may include frequency translation to a higher and or lower frequency (e.g., up conversion [translation] and or down conversion [translation]).

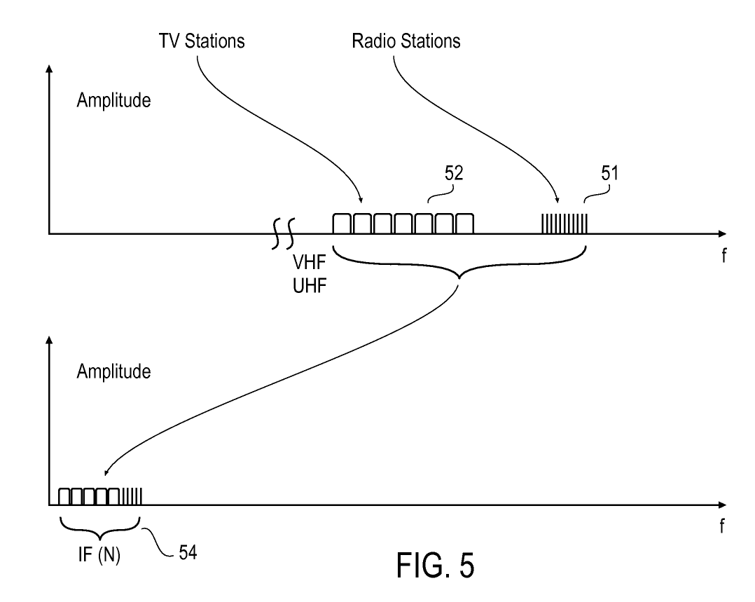

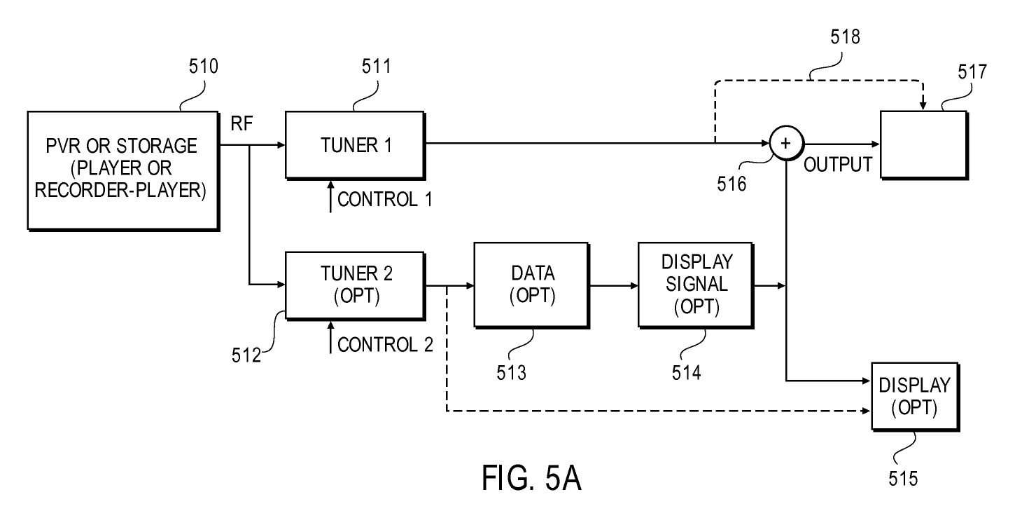

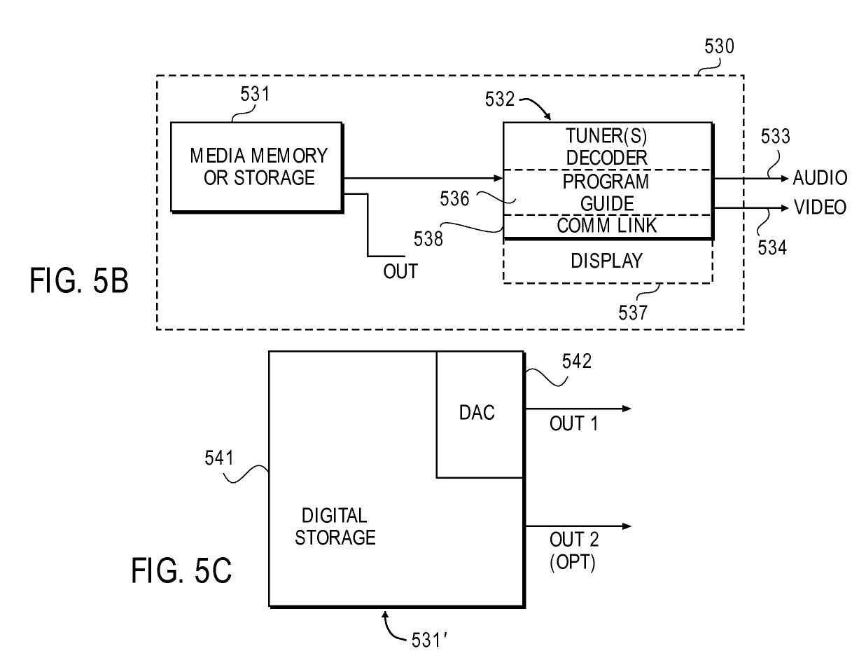

FIG. 5 illustrates an embodiment wherein television channels 52 and or radio channels 51, which are generally above the VHF band (e.g., >30 MHz), are translated down to IF(N) frequencies 54. One or more channel in the IF(N) frequency range then is digitized for recording. In this example, any number of television and or radio channels from channel 52 and or channel 51 may be chosen and then “mapped” via frequency translation to a lower frequency.

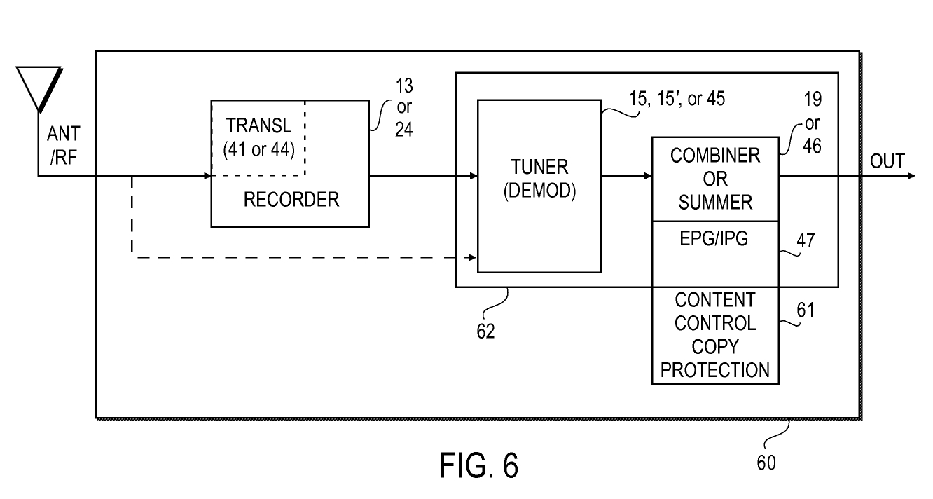

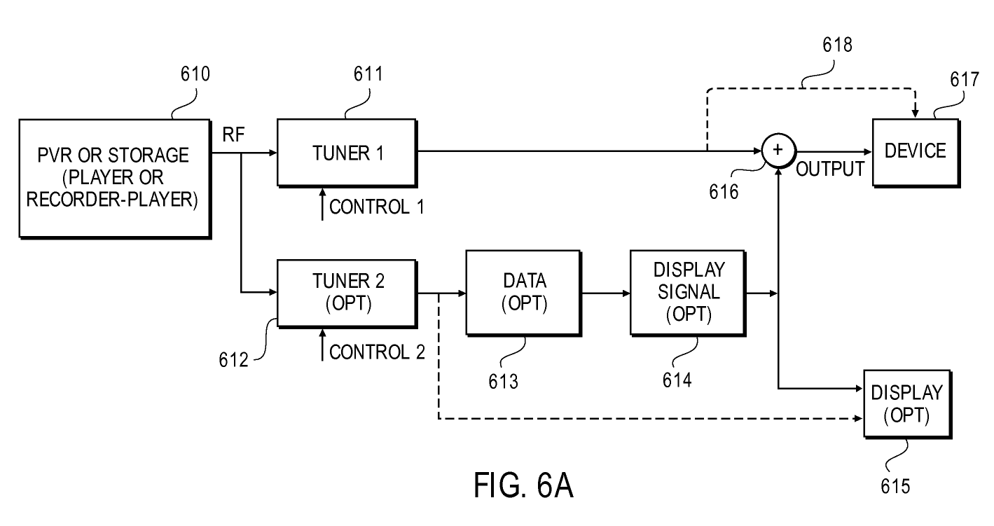

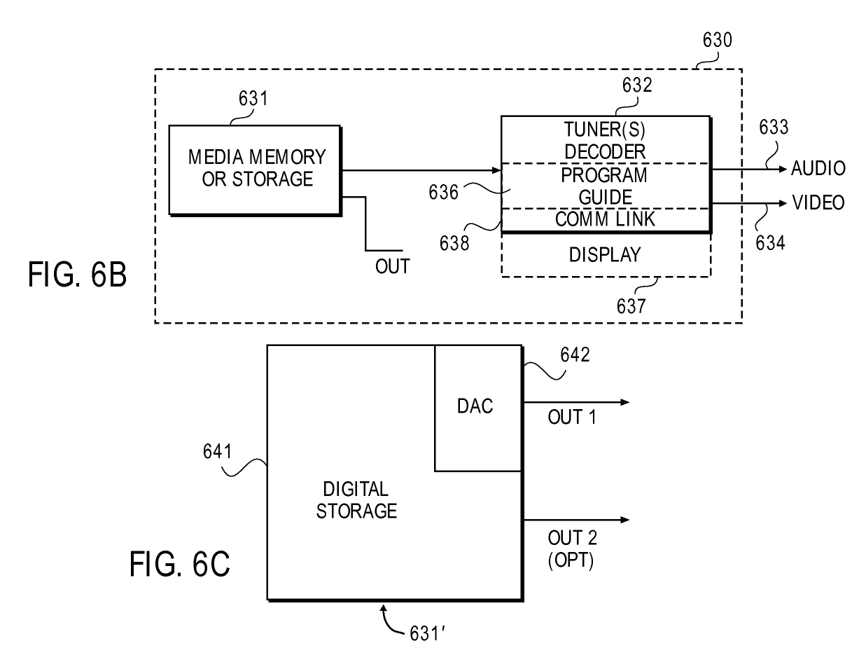

In FIG. 6, a tuner or recorder such as the recorder 13 or the recorder 24 discussed above may include electronic programming guides and or interactive programming guides (indicated by the block 47 within block 62), such as described in the U.S. Pat. No. 6,665,869 (the '869 patent), incorporated by reference. A tuner or recorder may be linked to a digital network or to another tuner/recorder such as described in the '120 patent. For instance, one or more of the tuner 15, tuner 15′, tuner-demodulator 45, electronic program guide 47, and or the summer 46 described above may be implemented in conjunction with a tuner/epg/combiner 62 and or the content control block 61 of FIG. 6, to provide at an output terminal that includes a program video signal, a programming guide, and or a content control/copy protection signal.

As illustrated in FIG. 6, an example embodiment of a system 60 includes an antenna or RF signal coupled to a recorder such as shown as block 13 or 24 in previous figures. In this example, the recorder 13 or 24 may include optionally a translation module 41 and or 44 of the previous figures, which may be implemented by a function or a circuit, and which then optionally translates in frequency a portion of the RF spectrum from the antenna or RF signal. The output of the recorder 13 or 24 is then a recorded RF signal, which is coupled to the tuner/epg/combiner block 62. Block 62 includes a tuner such as the tuner 15, 15′, or 45 of the previous figures. The tuner 15, 15′, or 45 may receive a signal from an output of the recorder 13 or 24, or receive a signal from the antenna or RF signal (as shown in dashed line). An output of the tuner (15, 15′, or 45) is coupled to an input of a combiner/summer circuit such as the combining circuit 19 (FIG. 2B) or the summer 46 (FIG. 4). The combiner/summer (19 or 46) may be coupled to an electronic program guide (EPG) 47 (FIG. 4) or interactive program guide (IPG), and or to a content control/copy protection signal source 61.

Thus, for example, an output terminal of the combiner/summer (19 or 46) may include a programming guide signal for viewing a set of one or more programs that is available or scheduled, and or a content control or copy protection signal to provide content control or copy protection of one or more video programs. For example, a programming guide from block 47 can provide a pattern of cells, which contains a list of times and or dates for movies or television programs. In terms of content control or copy protection, one or more bits from an output of the recorder (13 or 24) or the tuner (15, 15′, or 45) may be utilized to enable/disable or to program a content control and or copy protection signal for block 61.

U.S. Pat. No. 5,479,268 (the '268 patent) and US Patent Publication No. 2003/0149980 (the '980 publication), pertain to programming guides such as EPG (Electronic Programming Guide) and IPG (Interactive Programming Guide), and are both incorporated by reference herein in their entireties. An exemplary programming guide, which may be provided or derived via an IPG or EPG signal, is for example a method or apparatus allowing a user to select one or more (favorite) video channel(s). The guide includes providing to a display, e.g., via a screen, a number of cells representing a corresponding number of video channels available for viewing by a user, where each cell includes a channel number and/or a program service name for a particular channel. The user uses the display to select a channel among the number of channels; for example, changing a status of the selected channel to that of a favorite channel in response to the user selection, or displaying in cells corresponding to the favorite channels a visual indication that the selected channels are favorite channels, and providing program guide information for the subset of channels having said favorite status in response to the user's indication to view the program guide information.

Another example of a programming guide (for the blocks 62 and 47 of FIG. 6) includes a method or apparatus for navigating about a television or video listing including one or more steps of: storing in electronic or computer readable memory a number of television or video program listings, each listing including title, telecast time, and/or channel; displaying on a monitor screen some of the titles of the program listings in a grid format of time and channel; moving a cursor on the screen to mark one or more of the displayed titles in the grid guide format; opening to the marked title in a single or multiple format, which may instead be of the (original) grid guide format, where the single channel format includes rows (or columns) of sequential television or video program listings for the channel corresponding to the marked title; additionally including moving the cursor on the screen to mark a different displayed title in the single channel format; where the storing step stores programming listings and/or the displaying step displays simultaneously, with the program listings, the program notes corresponding to the marked title.

Such a grid pattern or cell may include straight or curved segments. Alternatively, a two dimensional grid pattern may be transformed to a three dimensional grid pattern or vice versa. Such a grid pattern may include three and/or two dimensional properties. For example, one cell to another cell in the programming guide may be represented in a curved surface and/or a solid object's sides. Cells may be of regular and/or irregular shape(s).

In another embodiment, when a broadband signal is recorded and played back, or played back providing an RF signal, an auxiliary tuner or secondary tuner may be used to scan one or more channels, and to read or retrieve programming information, data, or meta data from the one or more channels of the (e.g., played back) RF signal. The broadband recorder or player includes a display of the programming information of one or more channels played back from the broadband recorder or player.

In an embodiment including a player or playback device such as an optical reader (e.g., CD, DVD, and or Blu-Ray player), a solid state memory reader, and or a magnetic medium reader (e.g., hard drive, tape drive), the RF signal is stored in a medium and played back to one or more tuners for providing viewing of video signals, listening to audio signals, and or displaying data, programming guides, and or retrieving data.

FIG. 6A shows an embodiment of a player or recorder-player 610 providing an RF signal from playback of a recorded medium or storage device. Player/recorder-player 610 provides the RF signal to an input of a first tuner 611. An output of tuner 611 provides a video and or audio signal, which may be coupled to a device 617 (via a dashed line 618) such as for example, a display device, a recording device (e.g., base band recorder), a transmission system, audio device, and or to a link for upload to a digital delivery network (e.g., Internet).

Optionally in FIG. 6A, an input of a second tuner 612 is coupled to the RF output of player/recorder-player 610. Second tuner 612 may be set to scan one or more channels from the RF signal of device 610, and or second tuner can provide a video and or audio output of a selected channel (e.g., same channel or different channel selected from the first tuner, 611). An output of the second tuner 612 is coupled to an input of a data reader 613, which gathers and or stores information such as programming information for one or more selected or scanned channel. An output of the data reader 613 is coupled to data-to-video signal converter, 614, such as an alpha numeric data-to-video display signal converter (e.g., converts numbers and or letters extracted from data of tuner 612 to be formatted for viewing on a display such as via a character generator).

Display signal converter 614 may format the alpha-numeric information to be displayed in one or more portions of one or more active video fields. For example, an output of data-to-video signal converter 614 may be displayed in a certain section of the TV field such as in the center, corner, edge, letterbox area, etc. The output of the data-to-video signal converter 614 sends a signal to an auxiliary device 615, such as a device including a display (e.g., remote control, PDA, cell phone, media device, computer, etc.)

In one example, the output signal from signal converter 614 may be coupled to a separate video display, and or added, combined or inserted with the video signal from the first tuner 611 via a combiner function or circuit 616. For example, a first input of combiner function/circuit 616 is coupled to an output of tuner 611, and a second input of the combiner function/circuit 616 is coupled to an output of the data-to-video signal converter 614. An output of the combiner function/circuit 616, which includes video signals from a selected channel from the first tuner 611, and the video signals indicative of or including data or programming information of one or more channels, is then coupled to device 617. As previously described, device 617 may include a display, transmission system, receiver, recorder, and or storage system.

Another embodiment includes an audio player (or video player), wherein the audio or video player provides a played back RF signal via a recorded media. The RF signal is demodulated and or decoded into digital and or audio signal(s) to provide a user the capability of selecting one or more “channels” stored on the recorded media. For example, the recorded media may include solid state memory, optical storage, and or magnetic storage device(s). Examples of channels may include HD radio, radio feeds, Internet radio, audio programs, etc, which are stored for example, digitally.

More particularly, FIG. 6B illustrates such an embodiment of a media player 630, which generally includes an audio player (or video player), wherein an output of the audio or video player is coupled to a tuner to select one or more channels or stations from a recorded broadband RF signal. The recorded signal (e.g., broadband RF and or baseband) is played back via a storage device player 631, which provides the broadband RF signal, including one or more channels, and or a digital signal (e.g., digital audio and or video signal, to an input of a tuner/decoder/program guide 632. For a broadband RF signal (e.g., including one or more channel or station), a tuner is utilized to demodulate the RF signal, for example, into a digital audio or video signal. Tuner/decoder/program guide 632 may include a decoder for digital signals. The decoder may decode MPEG (Motion Picture Expert Group), Wavelet Transform, DCT (Discrete Cosine Transform), signals, or decompress digitally compressed signals.

In one embodiment, the user may select via the tuner between one channel and another for different programs (e.g., audio and or audio plus video programs, songs, tunes, etc.). Optionally, the user may select a second tuner within the media player 630 to receive one or more stations, and or use the second tuner for gathering data to provide an associated programming guide (e.g., name of program, name of song, etc.) of one or more channels or stations, while allowing the first tuner to receive and play a selected station or program.

Media player 630 may include a display, 637, for displaying information, such as programming, date and or time, data, metadata, and or identifying a channel/station on a selected channel from the first tuner, and or displaying such information on one or more channels or stations via the second tuner.

A programming guide 636 includes information received from a wireless source such as from the Web, satellite, cable, Ethernet, LAN, WiFi, Wimax, broadcast, optical links, and or from communication links to a Comm Link 638, and or via one or more tuners within media player 630.

An output terminal 633 may include an analog and or digital audio signal, and or an output terminal 634 may include an analog and or digital video signal.

It should be noted that media player 630 may include non broadband RF recorded signals such as standard digital audio, video, and or photo signal(s) (e.g., MPEG, REG, Wavelet). Thus media player can playback in any proportion of broadband RF and or standard type digital files to provide audio and or video programming.

FIG. 6C shows an example of a storage device 631′ that includes digitally stored (e.g., broadband) RF signals and or typical or conventional digital audio and or video signals via a recorded medium 641. One output terminal, OUT1 provides an analog RF signal via a digital to analog converter 642. Optional output terminal OUT2 provides a typical or conventional digital audio signal from the recorded medium 641.

In another embodiment, a novel video recorder may store or record more information than the conventional program video and audio signals. For example, when recording a TV program via an RF signal (e.g., off the air, cable, satellite) or a digital delivery network, Internet, etc., the recorder may include recording any combination of the following: The video program in standard and or high definition video standard, the audio program associated with the video program such as mono and or stereo audio signal(s), the DVS (descriptive video service) audio channel, the SAP (second audio program) channel, data relating to time and or date (e.g., time code and or date code), programming guide information, closed caption data, and or channel information (e.g., channel number, station call sign, and or network identification). So for example, when a video program is played back, normally the only information played back is the video program (e.g., movie, television show, etc.) and audio channel signal that is set by the user (e.g., either main channel audio or SAP, but not both). In this embodiment the video is played back with the video signal (e.g., with a choice of selecting standard and or high definition video signal(s)) and (or) with the selection of more than one audio channel upon playback (e.g., the user may select main channel audio, SAP audio, and DVS audio channel(s)). Alternatively in this embodiment (e.g. upon playback or record and playback), the user may access to a display (or via a voice signal) the channel or program identification (e.g., channel number or channel call letters/sign), the name of the video program that is being played back, closed caption information/data, and or and programming guide information (e.g., name of the program before or after the presently played back program for a selected channel).

In another embodiment, a recorder stores or records other information such as SAP and or DVS signals, closed caption data, programming guide information, time and or date. Channel identification can distribute or send any of this other information to another device such as a cell phone, remote control, network device, computer, and or television. For example, when the recorder is playing back the video and audio signals, the recorder also is capable of distributing the other information via a transmitter, a cable, and or optical communication system to another (e.g., external) device. The “another device” (e.g., a remote control, digital media device, computer, network device, cell phone, television device which may include a mobile television device, iPad, iTouch, etc.) then displays the closed caption, and or plays back the SAP and or DVS audio channel, programming guide information, time and or date, and or channel information/guide/identification, of a previously recorded video program. For example, during the playback of a video program, the playback device may send information to an external device, which can display the program information (e.g., title of the video program), display closed caption, display time or time code, and or provide audio of the SAP and or DVS channel(s).

Alternatively, in another embodiment, an analog video output of a set top box, a media player, a personal video recorder (PVR), IPTV (Internet Protocol Television) device, receiver, computer, PC, and or tuner may include a weakened color stripe signal, and or a copy protection signal, that provides resistance to a circumvention device, for example a “black box.” As mentioned, weakened color stripe used for content control provides excellent playability of the copy protected video signal on a television set. In one example, a content control or a copy protection signal that provides resistance to a circumvention device, includes signals that causes the circumvention device to pass at least one or some of the content control signals. This causes a compliant device to stop recording even after the circumvention device is connected between a video playback device (that provides the circumvention resistant content control or copy protection signal), and an input to a compliant recorder (e.g., PVR).

Alternatively, in another embodiment, an analog video output of a set top box, a media player, a personal video recorder (PVR), IPTV (Internet Protocol Television) device, receiver, computer, PC, and or tuner may include a content control or copy protection signal. In this embodiment, playability is improved on a display device by changing a set of content control or copy protection signals that originally alternated from one adjacent line to another, to provide a different pattern such as ABABAB . . . , wherein A is one set of a number of added pulses per television line, and B is a different set of a number of added pulses per television line. Added pulses may include pseudo sync pulses and or AGC pulses. For example, A=6 (or 7), B=7 (or 6), and of course other numbers can be used. Improved playability is provided in an embodiment when two or more consecutive television lines have the same pattern. For example, have a set of a content control or copy protection signal that includes two or more consecutive television lines with an “A” pattern, or two or more consecutive television lines with a “B” pattern, to provide an improved playability video content control or copy protection signal.

In another embodiment such as a digital network or digital signal transmission system or environment, a system operator providing streaming, broadcasting or distributing video programs through an RF signal, Internet, or digital delivery network, may include control bits to turn on or off any content control or copy protection signal(s). Such signals may include an improved playability video content control or copy protection signal, a content control or copy protection signal resistant to circumvention devices because the signal causes the circumvention device to pass sufficient added pulses to a compliant device (e.g., PVR) such that the compliant device shuts down recording or fails to engage the record function of the recording device, and or a weakened color stripe signal for a receiving device coupled to one or more signals provided by the system operator.

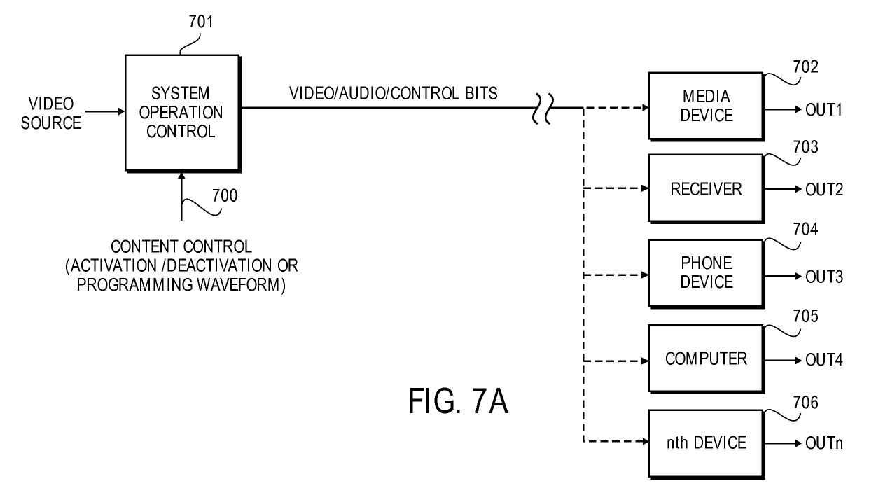

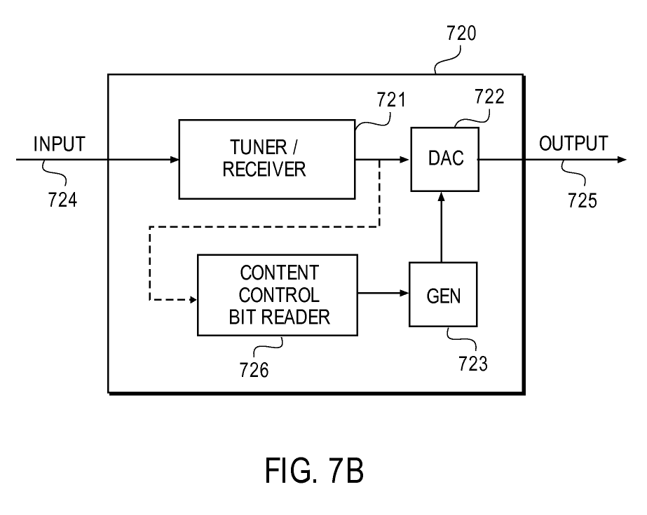

FIG. 7A illustrates such an embodiment including a system operator (S.O.). A video signal including one or more video program (e.g., television show, movie, news, etc.) is coupled to a system operator control module or function 701. A content control or copy protection signal for providing/enabling control bit(s) is provided at input 700 and is combined with the video signal via the control module or function 701. The combined video/audio/control bit(s) signal is distributed via optical, radio frequency, wired, and or wireless mode(s) of transmission to one or more devices such as media device 702, receiver 703, phone device 704, computer 705, and or nth device 706. When control bits are activated or enabled in a particular bit pattern, any combination of the devices from 702 to 706 provide a content control or copy protection signal at an analog output that includes an improved playability video content control or copy protection signal, a content control or copy protection signal resistant to circumvention devices by causing the circumvention device to pass sufficient added pulses to a compliant device (e.g., PVR) such that the compliant device shuts down recording or fails to engage the record function (e.g., correctly) of the recording device, and or (e.g., providing) a weakened color stripe signal.

In another embodiment any of the devices 702 to 706 (e.g., at an analog output) may have as for example a default condition provide an improved playability video content control or copy protection signal, a content control or copy protection signal resistant to circumvention devices by causing the circumvention device to pass sufficient added pulses to a compliant device (e.g., PVR) such that the compliant device shuts down recording or fails to engage the record function of the recording device, and or a weakened color stripe signal. In one example with the default condition in any of the devices 702 to 706 to provide any content control signal as previously described, the control bit(s) from the system operator may be used to selectively turn off a portion of one or more of the content control or copy protection signals. Such signals for example as, an improved playability video content control or copy protection signal, a content control or copy protection signal resistant to circumvention devices by causing the circumvention device to pass sufficient added pulses to a compliant device (e.g., PVR) such that the compliant device shuts down recording or fails to engage the record function of the recording device, and or a weakened color stripe signal.

In another example, any of the devices 702 to 706 may ignore control bit(s) from the system operator to output any of the content control or copy protection signal as previously described (e.g., an improved playability video content control or copy protection signal, a content control or copy protection signal resistant to circumvention devices by causing the circumvention device to pass sufficient added pulses to a compliant device (e.g., PVR) such that the compliant device shuts down recording or fails to engage the record function of the recording device, and or a weakened color stripe signal).

FIG. 7B shows at least a portion of an “nth” device that is coupled to a video signal and or control bits provided by a system operator. A digital video signal that may or may not include control bit(s) is coupled to an input of a device 730. Typically this digital video signal is coupled to a tuner 721, or a receiver function or circuit for recording digital signals from a digital network (e.g., Internet, LAN (local area network), WiFi, WiMax, Ethernet, etc.). Alternatively, tuner/receiver 721 may include at least a part of any combination of a computer, cell phone or a media player such as a DVD player, solid state memory player, Blu-Ray player, PVR, set top box, car stereo, etc. An output of tuner/receiver 721 may include control bit(s) or a bit pattern for applying at an output 725 of a DAC (digital to analog converter) 722 one or more part of; an improved playability video content control or copy protection signal, a content control or copy protection signal resistant to circumvention devices by causing the circumvention device to pass sufficient added pulses to a compliant device (e.g., PVR) such that the compliant device shuts down recording or fails to engage the record function of the recording device, and or a weakened color stripe signal. A generator 723 receives a signal from a content control/copy protection bit reader 726 which, in turn, is responsive to the tuner/receiver 721, to enable or disable any portion of a content control or copy protection signal output from the DAC, 722.

For example the provision of one or more pseudo sync pulses (for a set or series of television lines) in a television line immediately, or one line delayed, after the last television line containing a post equalizing pulse, causes a circumvention device to pass at the circumvention device's output, an effective and or enhanced copy protection or content control signal.

The following patent applications which were filed in 2009 to Ronald Quan, or Ronald Quan and John Cloutman, are related to weakened color stripe signals and or signals providing resistance to certain circumvention devices, and are incorporated by reference: 2010/0054469; 2010/0171880; Ser. No. 12/563,050; and 2010/0054700.

Thus, alternative embodiments include a content control, or type RP signal, where R refers to resistance and P refers to playability. Ergo, a RP signal provides resistance to a circumvention device or provides improved playability, or a weakened color stripe protection signal from an integrated circuit improves geometric distortion for better playability, a content or type RP or weakened color stripe protection signal reduces or defeats the function of a circumvention device, and/or a content or type RP or weakened color stripe protection signal from an integrated circuit triggers or causes a circumvention device to enhance copy protection effect(s). Such content or type RP or weakened color stripe protection signals may be utilized in an integrated circuit including a digital to analog converter coupled to a source of digitally recorded material or digital video for providing a baseband video signal from a digital signal, a signal sensing or reader circuit for detecting or reading a copy protection bit, a bit pattern or content control bit(s), and a signal generator for generating a content or type RP or weakened color stripe protection signal at the output of the digital to analog converter in response to the copy protection bit, bit pattern, or content control bit(s).

Further embodiments of the invention include any of the following. A method where the copy protection signal is supplied via an output of the integrated circuit to an input of the circumvention device, where the output of the circumvention device passes at least part of the protection signal sufficiently for a protection or content control effect, and/or where the output of the circumvention device provides a signal to further distort or blank a portion of an active television field. A method where the protected video signal from the integrated circuit is coupled to an input of the circumvention device, where the output of the circumvention device supplies a signal that is substantially effective in terms of copy protection or content control for a video recorder or for a content control system. A circuit for inserting or adding, in at least one television line, one or more pseudo synchronization pulses or one or more pseudo synchronization pulse or AGC pulse pair signals immediately after or less than two or two and a half lines after a vertical synchronization signal or post equalizing pulse (e.g., in an odd field, even field, or both fields) to, for example, provide resistance to a circumvention or black box device.

Another embodiment includes a method of providing a different number of pseudo synchronization pulses from one video line to another video line and/or different pseudo synchronization pulse widths from one video line to another, generating at least two lines consecutively with substantially the same number of pseudo synchronization pulses and/or substantially the same pseudo synchronization pulse width, e.g., for improved signal playability.

In another embodiment a content or type RP signal, or weakened color stripe protected video signal, is supplied to a television set via an output of a receiving device, wherein improved playability is achieved e.g., via reduced “hooking” on a top portion of the television e.g., by shifting the pseudo synchronization line locations closer to the vertical synchronization signal, or by reducing pseudo synchronization pulse(s) near the beginning of the active field, or by providing two or more consecutive television lines with the same or substantially the same number of pseudo synchronization pulses if the number of pseudo synchronization pulses alternates from line to line.

Another embodiment includes a method of starting or providing pseudo synchronization pulses immediately after or less than two or two and a half lines after a vertical synchronization signal or post equalizing pulse, to provide the content or type RP protection signal at an output of the integrated circuit, and may include one or more of the following: a color burst modification of whole or segmented portions of one or more color burst envelope which includes one or more cycle of incorrect color burst, a weakened color stripe signal, level shifting of a portion of the video signal including lowering or raising one or more portions of the video signal, modifying synchronization location, amplitude, and/or pulse width in selected video lines, providing back porch pulses of different video levels from one video line to another, providing pseudo synchronization and/or AGC pulses of different pulse widths from one video line to another, providing pseudo synchronization and/or AGC pulses of different numbers from one video line to another.

The protection signal is supplied via an output of the integrated circuit receiver to an input of the circumvention device, wherein the output of the circumvention device passes at least part of the protection signal sufficiently for a copy protection or content control effect, and/or wherein the output of the circumvention device provides a signal to further distort or blank a portion of an active television field.

Copy protection is provided by combining pseudo synchronization and/or pseudo synchronization and automatic gain control (AGC) pulses immediately after a vertical synchronization signal, or less than two or two and a half video lines after a vertical synchronization signal or post equalizing pulse, with the color burst modification, e.g. color stripe, partial color stripe, weakened color stripe. The combination signal is generated at an output of the integrated circuit, where the color burst modification includes cycles of incorrect phase or frequency in selected video lines, wherein the baseband, composite, and/or component output of the integrated circuit is coupled to an input of the circumvention device, and wherein outputting a content or type RP or weakened color stripe protection signal via the circumvention device unintentionally produces color distortions in the modified color burst of the copy protection signal and extra color distortion due to blanking or modifying of color burst envelopes in an active video field. Thus, copy protection is caused by the circumvention device, contrary to its intended purpose.

A type RP signal includes negative going pulses or pseudo sync pulses (e.g., one or more (negative) pulses per line) in one or more lines within two lines (e.g. <2 lines) of the last television line having post equalizing pulses in the vertical sync signal. In a standard pseudo sync process, the pseudo sync pulses occur two lines or more after the post equalizing pulses. Thus, there are two lines that are normally blanked or that normally have no negative going pulses after the last post equalizing pulse. Certain circumvention devices detect the lack of negative pulses for the one or two lines after the post equalizing pulses, to identify the start of the pseudo sync pulses in the vertical blanking interval. Once the start point is identified by these circumvention devices, the standard pseudo sync process is deleted by signal modification circuits in the circumvention devices. For example, in a 525 line system the last post equalizing pulse lines are at lines 9 and 271. And in a 625 line system the last post equalizing lines are at lines 5 and 317. A standard 625 pseudo sync pulse signal may start with pseudo sync pulses at lines 8 and 320, which is deleted by certain circumvention devices (black boxes). It was found experimentally, by providing/including one or more pseudo sync pulses in lines 6, 7, 318, and or 319 for a 625 line format (for a first type of RP signal), these certain circumvention devices did not sufficiently remove the pseudo sync pulses, and or the associated AGC pulses. Similarly in a 525 line format, providing/including one or more pseudo sync pulses in lines 10, 11, 272, and or 273 (for a second type of RP signal) caused certain circumvention devices to fail in sufficiently removing pseudo sync pulses, and or the associated AGC pulses. In at least one 525 line format circumvention device, providing a pseudo sync pulse(s) or negative going pulse(s) immediately after the last line of post equalization pulses (or end of vertical sync signal) causes this particular 525 line format circumvention device to fail. For example, a circumvention device failure in general includes passing, via its output content control/copy protection pulse(s)/signal(s) and or removing/attenuating (at least) a portion of the active field, or color burst signal. A portion of the active field may include one or more portions of one or more lines outside the vertical blanking interval.

An input to, for example a PVR or device with one or more embodiments, may include a video signal with a standard protection signal that is not resistant to a black box, wherein an output video signal from the device including one or more embodiments, provides a new protection signal resistant to circumvention devices and/or a new protection signal with improved playability. Further, an input to a device with one or more embodiments, may include a video signal with a content or type RP protection signal that is resistant to a black box (e.g., a black box or circumvention device that fails to sufficiently remove pseudo sync pulses and or associated AGC pulses for circumventing content control or copy protection), with an output video signal providing a protection signal not resistant to black boxes, and/or a new protection signal with improved playability. One or more type RP protection signal or one or more type of content control signal is described in U.S. patent application Ser. No. 12/711,834, Method and Apparatus for Receiving Metadata, EPG, or IPG Signals in an Integrated Circuit for Control Purposes, which is incorporated by reference.

It should be noted that the examples above showing placement of one or more pseudo syncs following immediately after a vertical sync signal (e.g., vertical sync signal including equalizing pulses) or 1 or 2 lines after a vertical sync signal, to provide/synthesize a content control signal or copy protection signal that provides resistance to black boxes or circumvention device includes providing an enhanced content control effect when a circumvention device is coupled to a (e.g. PVR or DVR) recorder. For example, a resulting recording of an illegal copy can result in blanking or altering the display of one or more lines of the viewable field or the active field via the circumvention device. The blanking or altering effect from the circumvention device may occur in an odd and or even television field. For example, blanking and altering effect caused by the circumvention device may occur in only one field (e.g., either an even numbered field or an odd numbered field) when one or more pseudo sync pulses (or a series of pseudo sync pulses) are inserted immediately after a vertical sync signal for one field, while one or more pseudo sync pulses or a series of pseudo sync pulses are inserted one or more television lines after a vertical sync signal on another field. This then provides an enhanced content control or copy protection effect because the circumvention device will cause a flicker effect (e.g., in a 525 and or 625 interlaced television system) when viewed through a monitor via the circumvention device and or via a play back of a recording.

In another example, when one or more pseudo sync pulses or a series of pseudo sync pulses are inserted immediately after a vertical sync signal, a circumvention device provides another enhanced effect by blanking or altering a visible or viewable portion of the television program for both television fields.

It should be noted that when one or more pseudo sync pulses or a series of pseudo sync pulses are inserted two or more lines after a vertical sync pulse, a circumvention device will effectively remove the content control or copy protection signal, and or the circumvention device will not cause blanking in an active or viewable portion of the television field.

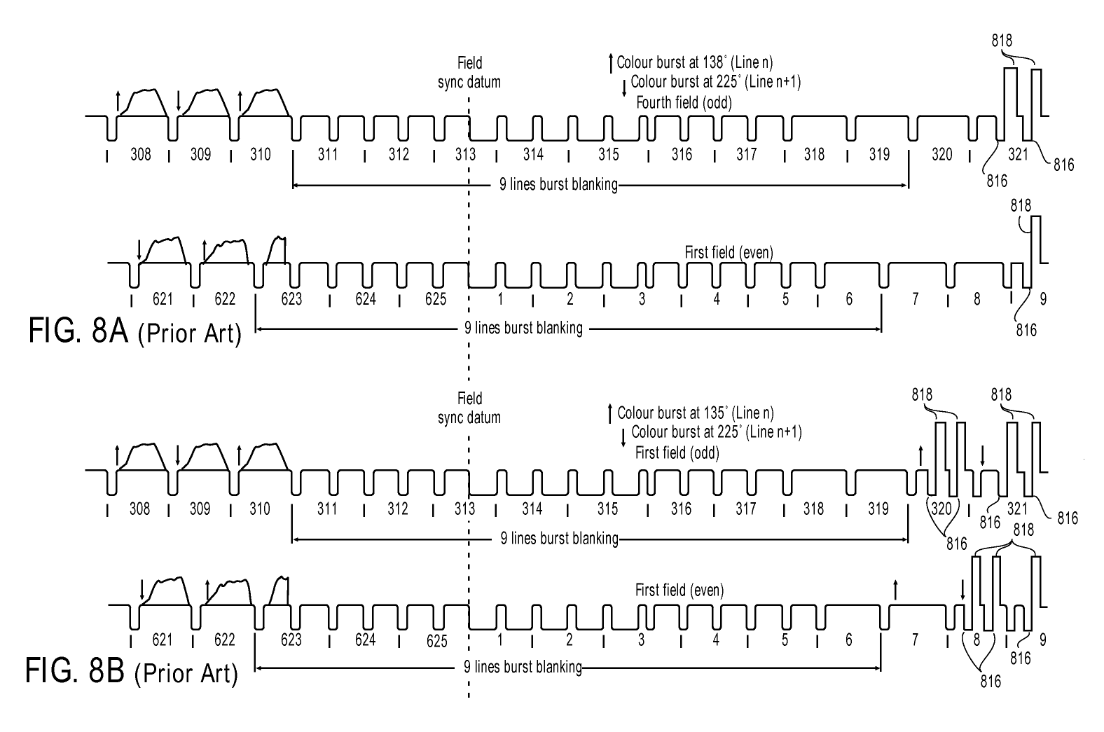

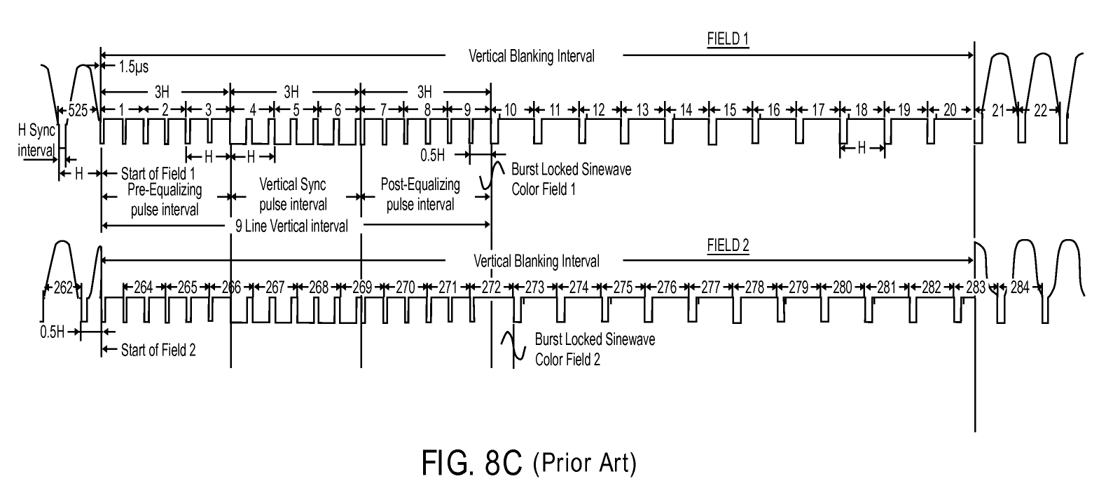

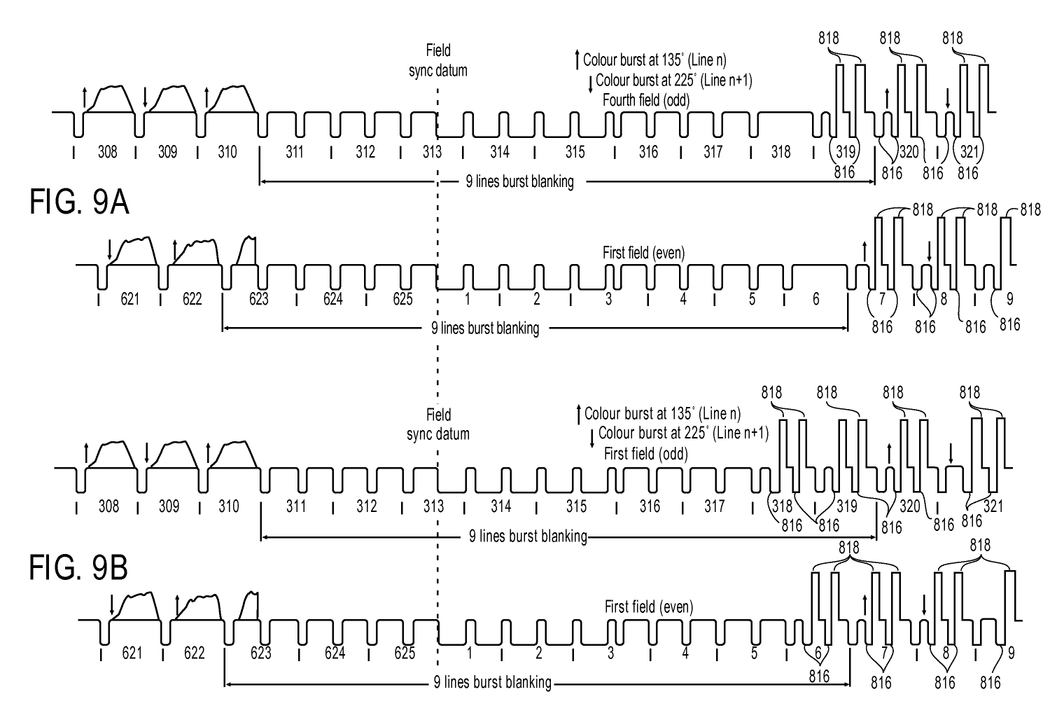

FIG. 8A illustrates a prior art example of a signal in a video home system (VHS) tape process for providing protection employing one or more pseudo sync/AGC (automatic gain control) pulse pairs starting in lines 9 and or 321 for a 625 line standard. Circumvention devices remove one or more of the pseudo sync/AGC pulses to allow a recordable copy. Pseudo sync pulses are illustrated by numeral 816 and AGC pulses are illustrated by numeral 818 in FIGS. 8A, 8B, 9A, and 9B.

FIG. 8B illustrates a prior art example of a DVD (or tape) process for providing copy protection employing one or more pseudo sync/AGC pulse pairs starting in lines 8 and or 320 for a 625 line standard. Circumvention devices remove one or more of the pseudo sync/AGC pulses to allow a recordable copy.

FIG. 8C illustrates a prior art example of the standard TV line allocation for a 525 TV line standard, NTSC.

FIG. 9A or 9B illustrate an embodiment wherein one or more pseudo sync pulse (or pseudo sync/AGC pulses) is inserted in lines 7 (or 6) and or 319 (or 318) for a 625 line standard example. This particular example of line assignment for pseudo sync (or pseudo sync/AGC) pulses causes some circumvention devices to experience one or more of the following (failures in intended function):
1) Fail in removing one or more (added) protection pulses, or still allow an effective protection signal or content control signal to be passed to a recorder or compliant device.
2) Fail in providing an improved playable video signal by degrading the video signal via blanking/attenuating/removing a portion of the active field (program) video picture.
3) Fail in providing an improved playable video signal by degrading the video signal via blanking/attenuating/removing at least a portion of color burst in TV lines near or in a portion of the active field (which for example, causes color to unlock at the top of the picture causing color distortion when recorded or played back, or when sent directly to a TV set.).

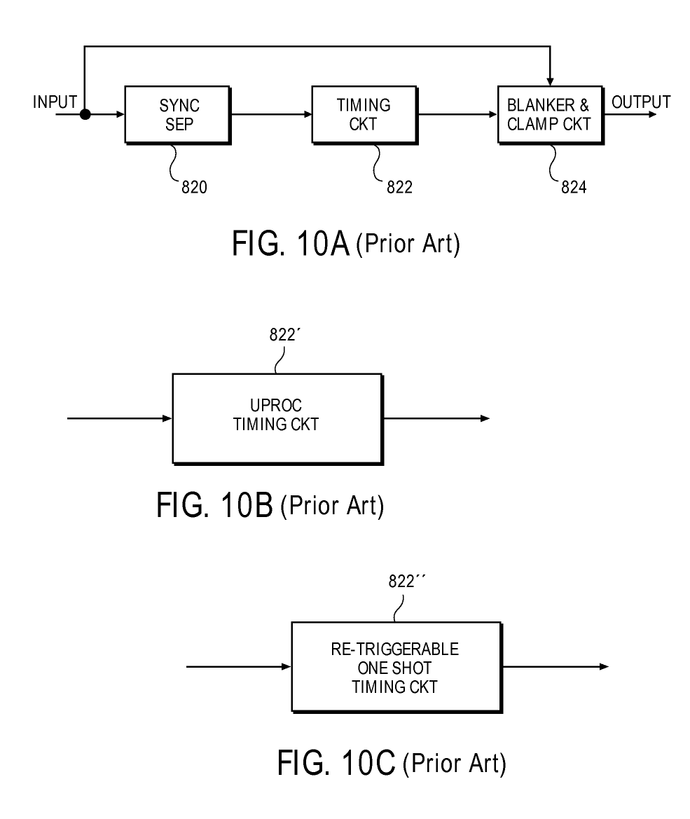

FIG. 10A illustrates a prior art circumvention device (black box), which removes (added) protection pulses typically located inside a portion of the vertical blanking interval (VBI). A protected video signal containing typically pseudo sync/AGC pulses as illustrated in FIG. 8A or 8B is coupled to the input of a sync separator circuit 820. The output of sync separator circuit 820 is coupled to a timing circuit, 822, which provides typically a logic signal coincident with line locations of the input's protection signal to a blanker circuit 824. Blanker circuit 824 then removes or replaces the protection signals with another signal such as a blanking level, which therefore removes pseudo sync/AGC pulses while passing substantially the video program from the input. This provides a new signal at the output of the blanker circuit 824, whereby the output of circuit 824 provides a recordable signal.

FIG. 10B shows an example of an alternative timing circuit 822′, which uses a microprocessor or computational circuit. Circuit 822′ may provide a signal to the blanker circuit 824 of FIG. 10A via an alternative method. For example, circuit 822′, as found experimentally, may require at least two lines of video that do not have a second (e.g., extra) negative going pulse during an interval of one horizontal line's duration (e.g., 63.55 usec or 64 usec) after the vertical sync signal. An example of this is illustrated in FIG. 8A where the last vertical sync signal ends on line 5, and (three) lines 6, 7, and 8 are free of negative going pulses within a horizontal line duration (before extra negative pulses such as pseudo sync pulses (816) appear on line 9 and other lines beyond). In a standard TV signal for 625 or 525 lines, the vertical sync signal always includes (extra or second) sync pulses that occur at twice the horizontal frequency. This means that one extra pulse is inserted between a TV line interval for the vertical sync signal, which typically includes equalization sync pulses and (serrated) broad pulses or vertical sync pulses. Circuit 822′ senses the one or more extra negative going pulses between a TV line interval (e.g., about 64 microseconds or 63.55 microseconds) to determine the presence of the vertical blanking interval (VBI). After two or more lines which do not include the extra inserted negative going pulse are determined, a blanking pulse is generated.

Similarly in FIG. 8B (two) lines 6 and 7 are free of (extra) negative going pulse(s) within one horizontal line's duration.

Timing circuit 822′ (FIG. 10B) searches for at least a two line gap free of (extra) negative going pulse(s) within a horizontal line duration, and provides a blanking pulse for the removal of the (added) protection pulses starting from lines 9 or 8, as illustrated in FIGS. 8A and 8B respectively. Thus, microprocessor timing circuit 822′ has no problem in providing a signal for removal of the (added) protection signals, as illustrated in FIG. 8A or 8B. However, for the waveforms in FIG. 9A or 9B, the pseudo spies occur in lines which the microprocessor timing circuit 822′ reads as still part of the vertical sync signal, and thus does not output a signal (e.g., for removal or defeating protection signals) until after the last line of protection signal (e.g., the last line in the VBI that still has pseudo sync pulses such as line 16, 17 or 18 or beyond). Circuit 822′ reads the pseudo sync pulses as equalizing pulses or some part of the vertical sync signal, and thus is programmed not to remove any pulses or signals resembling a vertical sync signal. Removing a vertical sync signal is prohibited by the microprocessor since this would cause a loss in vertical sync or cause a TV display to unlock field/frame-wise. Thus, careful line location (or placement) of the pseudo sync pulses for a protected video signal causes microprocessor timing circuit 822′ to allow passage of at least some or all of the pseudo sync or pseudo sync and AGC pulses to the circumvention device's output (terminal).

FIG. 10C illustrates another timing circuit, 822″, which includes a retriggerable one shot or equivalent. Essentially, circuit 822″ is turned to a high logic level without interruption during the presence of a vertical sync signal in the VBI. For example, if timing circuit 822″ is set to produce a 45 microsecond pulse, then when a vertical sync signal triggers the circuit 822″, a logic signal at the output of circuit 822″ is turned high during the vertical sync signal. The output of timing circuit 822″ is then high continuously because of the pulses between a TV line's interval, which retriggers and causes a high output due to 2H pulses that are spaced about 31.5 usecs or 32 usecs apart (e.g., pre/post equalizing pulses or serrated (broad) vertical sync pulses) in the vertical sync signal. When one or more pseudo sync pulses is added or provided to TV lines after the post equalizing (2H) pulses of a vertical sync signal, the one or more pseudo sync pulse also has the same effect on a retriggerable timing circuit as the 2H pulses. Thus, placement of pseudo sync pulses right after the vertical sync signal or the post equalizing pulse causes the retriggerable circuit to remain high, continuously from the vertical sync signal, until after the last TV line which includes pseudo sync pulses. A circumvention device (black box) that includes this type of retriggerable timing circuit thus will allow passage of some or all of the (e.g., newly placed) pseudo sync or protection signals to the output of the black box.

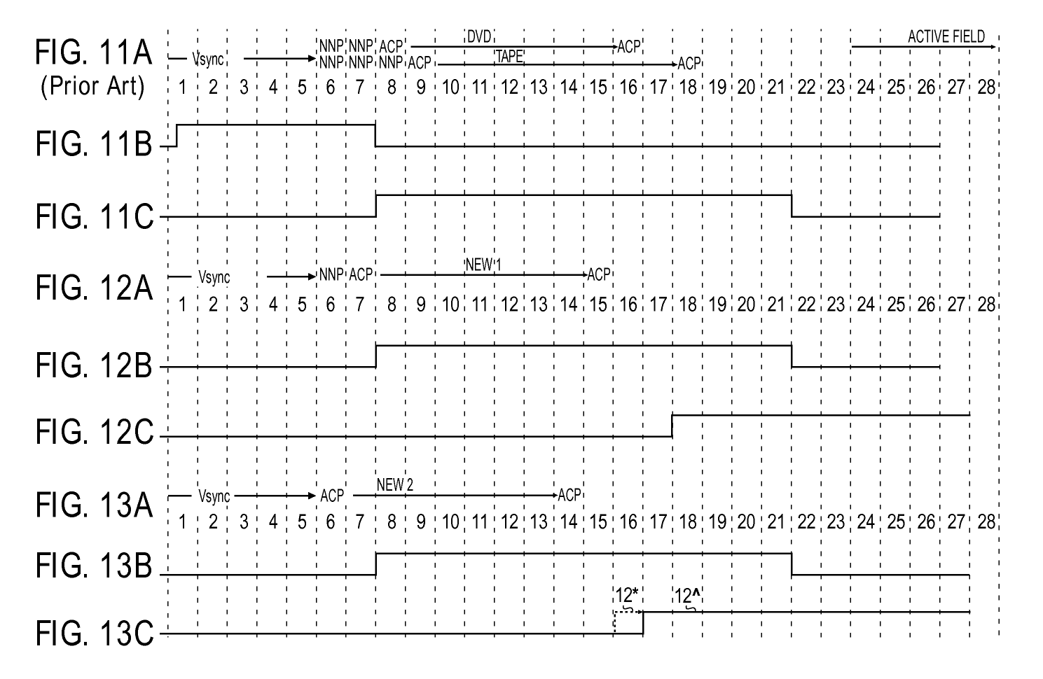

FIG. 11A illustrates a line location of prior art protection signals such as pseudo sync/AGC signals (ACP) in a 625 line standard format. For example, in video lines 8-16, the prior art ACP signal (e.g., for set top boxes or DVD players) is comprised of pseudo sync and AGC pulses. Similarly, for video tape, the prior art protection process is comprised of ACP signals (e.g., pseudo sync and or AGC pulses) from lines 9-18.

Also shown in FIG. 11A is the video line location from a vertical sync signal (e.g., such as including broad vertical sync pulses, and or post equalizing pulses) as lines 1-5 in a 625 (e.g., PAL or SECAM) TV standard.

FIG. 11A shows the beginning of the active field of the video signal as line 24 and beyond, and video lines 6 and 7 (or line 8 in a tape process) show that they have no extra negative pulse(s) (NNP).

FIG. 11B illustrates that the vertical sync signal is sensed by circumvention devices, and a timing signal is generated to yield/produce/provide a high to low logic signal transition at approximately line 8 of the VBI.

FIG. 11C then shows a pulse which is triggered by the pulse high to low transition of FIG. 11B, wherein the pulse in FIG. 11C is logic high from line 8 to about line 21 (or to at least line 18), which blanks or modifies the ACP signals as seen in FIG. 11A. With the prior art ACP signals of FIG. 11A, any of the timing circuits 822, 822′ and 822″ is effective in removing the ACP signals depicted in FIG. 11A.

FIG. 12A illustrates an embodiment for providing or synthesizing a new (Type RP) protection signal (e.g., NEW1). Here the copy protection signal, which includes negative going pulse(s) (e.g., one or more pseudo sync pulse) and or positive going pulse(s) (e.g., one or more AGC pulse(s)) that is/are inserted in line 7. Note that in this example, there is one video line (e.g., line 6) free of one or more extra negative going pulse after the vertical sync signal. One embodiment includes a one line gap (e.g., line 6) between a vertical sync signal and a protection signal including negative going pulse(s).

FIG. 12B illustrates that protection pulses are mostly removed by a timing circuit 822 or 822″, which allows the recording of a copy. To the contrary, FIG. 12C shows that the (added pulse) protection signals are not removed by timing circuit 822′ (e.g., microprocessor timing circuit). Instead, at least a line (e.g., lines 24 to 27) of the active field is/are removed or blanked out. The reason for the erroneous operation of the circumvention device is because the microprocessor circuit 822′ is expecting at least two lines free of (negative going, equalizing, and or pseudo sync) pulses between two horizontal intervals. In FIG. 12A, the new (Type RP) protection signal has only one line free of negative pulses between two horizontal (e.g., blanking) intervals. Recall that the post equalizing sync pulses and pseudo sync pulse(s) are (extra) negative going pulses between two horizontal blanking (or line) intervals.

FIG. 13A illustrates another embodiment (e.g., NEW2) where the negative going pulses are added to a line adjacent to the vertical sync signal (e.g., line location of post equalizing pulse(s)). For example, in the PAL standard or 625 TV line standard, the end of the vertical sync signal may be the last post equalizing sync pulse on lines 5 and/or 317. So an embodiment of the invention may include adding pulses (e.g., negative going pulses, pseudo sync pulses or pulse pair signals) on lines 6, 7, 318, and or 319. Similarly, in a 525 TV line standard (FIG. 8C), pulses may be added, as described above, on lines 10, 11, 272, and or 273.

In another example, such as in a PAL standard, as long as there is no more than one video line after the vertical sync signal that is free of (extra) negative going (e.g., pseudo sync, or an extra sync) pulse(s), certain circumvention devices are defeated by the (Type RP content) protection signal. Thus, an embodiment includes a number of lines containing negative going pulse(s) immediately after, or one line delayed from, a post equalizing vertical sync pulse (or a vertical sync signal). This number of lines may be consecutive in terms of containing negative going pulses, such as pseudo sync pulses, or may have one line in a set or series of TV lines that does not have the (e.g., extra) negative going pulses.

In one embodiment, typically 6-14 lines in the VBI (and or its vicinity) including 2-8 pseudo sync pulses or pulse pair signals (per line), begin at lines 6, 7, 318, and or 319, for a 625 (PAL or SECAM) line standard. Similarly, in a 525 NTSC, or equivalent line locations for NTSC or PAL-M line standard, the pulses begin at lines 10, 11, 272, and or 273.

FIG. 13C illustrates that there is no video line that is free of an extra negative going pulse(s) (e.g., no gap) because post equalizing pulses (e.g., line 5 part of a vertical sync signal) are followed in the next line with other negative going pulse(s) such as for example, pseudo sync pulse(s) on line 6 (in FIG. 13A). Thus, both timing circuits 822′ and 822″ fail to provide the correct blanking or removal pulse. Instead, the (Type RP) protection pulses of FIG. 13A are not removed or reduced, while blanking or removing occurs in a portion of the active video field. Modification or blanking of a portion of the video signal is denoted by the logic high states of signals 12* and or 12̂. In FIG. 13C, signal 12* shows how a circumvention device would remove or modify a portion of the signal from line 16 to a portion of the active field, while passing at least an effective number of protection signals residing prior to line 16. Similarly, signal 12̂ shows again how a circumvention device would blank, attenuate, or modify a portion of the video signal from video line 17 to a top portion of the active video field, while allowing passage of protection signals prior to line 17.

It should be noted that the circuit 822 of FIG. 10A still effectively removes the new copy protection signal of FIG. 13A.

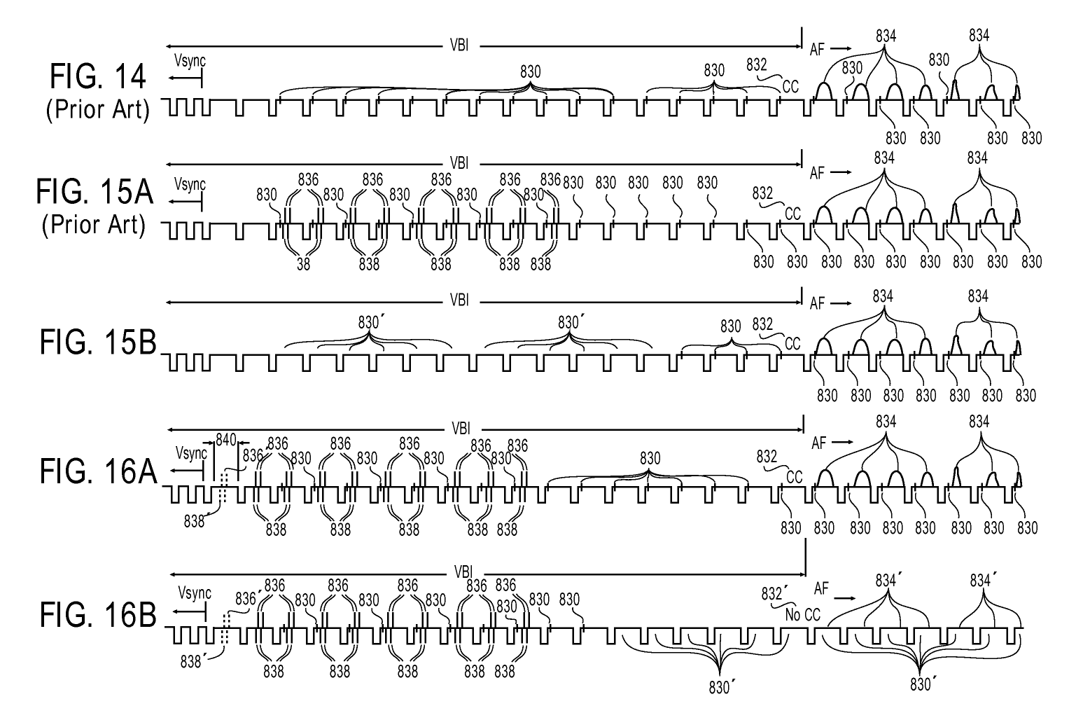

FIG. 14 illustrates a typical or standard video signal in a portion of the vertical blanking interval (VBI) and active television field. Color burst envelopes, which are used in recorder and or TV sets for proper color decoding or reproduction, are denoted by numeral 830. A Closed Caption (CC) data line or data signal is denoted by numeral 832. Active field (AF) program video (line) is illustrated by numeral 834.

FIG. 15A illustrates a prior art protection signal including AGC pulses 836 and pseudo sync pulses 838.

Just for illustration purposes, the number of pseudo sync and AGC pulses in FIGS. 15A, 16A and 16B, are shown to have 2 pulse pairs per TV line, but any number greater than or equal to 1 pulse pair (or greater or equal to 1 pseudo sync) per line may be implemented in, for example, the FIGS. 15A, 16A, and or 16B.

FIG. 15B illustrates the effect of a circumvention device utilizing, for example, the timing circuit 822′ of FIG. 10B. The prior art copy protection signals 838 (pseudo sync) and 836 (AGC) shown in FIG. 15A, are removed, and so are a number of color bursts 830 of FIG. 15A removed in the VBI. The removal of color bursts is depicted in FIG. 15B by numeral 830′.

FIG. 16A illustrates an embodiment of a new or Type RP protection signal where the (added pulse) protection signals start sooner than the prior art protection signals; that is, start in the first or second line after the vertical sync signal. In FIG. 16A there is only a one line gap 840, which is free of added negative pulses (e.g., new protection signal may include pseudo sync and or AGC) or “extra” negative going pulses (838′, or 838′ and 836′) after the vertical sync signal.

FIG. 16B then illustrates the effect(s) of a circumvention device mishandling the new (Type RP) protection signal (e.g., pseudo sync and or AGC pulses) shown in FIG. 16A. Here a microprocessor timing circuit 822′ (for example) causes the particular prior art circumvention device to pass one or more or all of the (added pulse) protection signals (e.g., pulses 838 and or 836) to the circumvention device's output, which action is opposite to the intended function thereof, thereby still providing the (black box's) output with an effective (Type RP) protection signal. Furthermore, the output of the prior art circumvention device includes the loss of the color bursts of FIG. 16A, into a top portion of the active field TV lines, which will cause noticeable and viewable color demodulation problems. The removal and thus lack of color bursts is depicted in FIG. 16B by numeral 830′.

Also, because a portion of the active video field is missing or blanked out, the effectiveness of the (content control) protection is enhanced. For example, signal 834′ denotes a blanked or altered portion of the active field video program signal 834 of FIG. 16A. For example, one or more or all of the protection signals is/are passed to the output of the circumvention device. But, the circumvention device also provides a blanked portion of viewable video, and/or provides loss of color burst, as depicted by numeral 830′(blanked or modified color burst) in FIG. 16B, in sufficient TV lines to cause errors in color demodulation or decoding in a TV set or recorder. So by providing or synthesizing the new protection signal, certain black boxes actually increase the effectiveness of the enhanced and or new protection signal. Alternatively, the certain circumvention devices cause playability problems on TV monitors as, for example, by blanking or modifying one or more color burst signals (e.g., FIG. 16B, numeral 830′).

Also shown in dotted lines in FIG. 16A or 16B, is an alternative new protection process (e.g., Type RP content control signal) where protection signals 836′, 838′ are added in the first video line interval after V sync, whereby there is no TV line free of protection signal(s) or negative going pulses after a vertical sync signal. This alternative embodiment works similarly in that one or more or all (added pulse or Type RP) protection signals are passed to the output of the circumvention device (e.g., circumvention devices that utilize for example, a microprocessor timing circuit 822′ (FIG. 10B) or a retriggerable timing circuit 822″ (FIG. 10C). The circumvention device further enhances the new protection process by blanking out a portion of an active field (as depicted by numeral 834′, FIG. 16B), and or causes improper locking of color reproduction on a TV monitor or recorder as, for example, by blanking or modifying one or more color burst signals (as depicted by numeral 830′). It should be noted for clarity in the illustrations for FIGS. 15A, 16A, and or 16B, one or more color burst envelope is not necessarily labeled as 830 on every line.

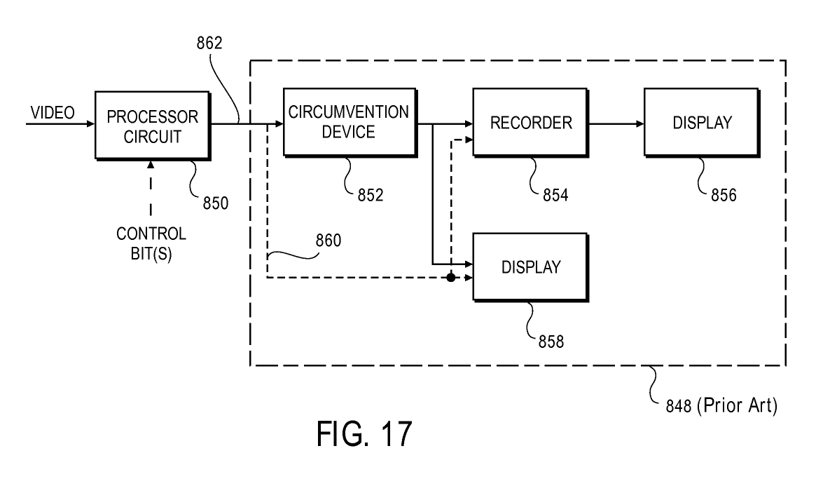

FIG. 17 illustrates an example of an embodiment including a processor circuit 850. Circuit 850 may be part of an integrated circuit, which receives video in analog and or digital form. Circuit 850 outputs a video signal that provides a (content) protection effect and reduces the effectiveness of a circumvention device. To this end, the apparatus may include control bit(s) to configure (any of the) various versions of the waveforms (e.g. FIGS. 9A, 9B, 12A, 13A, and or 16A) and or to enable or to disable any version of the protection signal at the output of processor circuit 850. For example, digital video may be coupled to an input of processor circuit 850, which may include one or more waveform circuits (e.g., fixed or programmable) to synthesize one or more negative going pulse, or one or more pulse pair signal including sync/pseudo sync and AGC pulse. The negative going pulse(s) are included immediately following, or in the next line after, a vertical sync signal, or in a first/second line after a vertical sync signal that is typically outside a sync interval or location. Circuit 850 may include an encoder and or digital to analog converter to provide a signal of one or more TV standards. The signal may include a (Type RP) content protection signal that is resistant to black boxes, a copy protection signal that causes a black box to further discourage copying and or to cause the black box in conjunction with the (Type RP) protection signal to provide a synergistic protection effect.

A synergistic effect may include passing one or more (added pulse) protection signals or pulses to the output of the circumvention device, which causes darkening or other protection effects on a recording, while causing the circumvention device to implement one or more of the following artifacts:

1) A clamp error in a portion of the program video signal, which causes level shifting, typically undesirable, in a part of the video signal.

2) A loss of color burst in one or more active TV lines.

3) A loss of program video information in one or more active TV line, which can include darkening or a blanking near or at the top of the display (or from a recorder).

4) Color unlocking or color distortion (e.g., errors in hue and or saturation) in one or more active TV lines, which can lead to incorrect color displayed on one or more lines near or at the top of the display, or loss of color for one or more lines near the top of the display. Recorders may also exhibit extra color unlocking (or color distortion) upon record and or playback.

5) New or increased playability artifact(s) when coupled to a TV display, which can include both (or either) color and extra darkening (or blanking and or attenuating) effects on a TV display and or a recorder.

Processor circuit 850 may include control bits or one or more bit patterns to enable, configure, and or disable at least a portion of the (content or Type RP) protection signal.

Also illustrated in FIG. 17 is an exemplary prior art circumvention device (“black box”) 852 (e.g., a circumvention device with a timing circuit 822′ or 822″), a recorder 854 coupled to the prior art circumvention device 852, and a first display 856 that is coupled to the recorder. Also shown is a second display 858 coupled to an output of circumvention device 852.

Dashed line 860 depicts a “bypass” mode where the new protection signal is coupled directly to recorder 854 and display 858. In this bypass mode, the new protection signal has little or no artifacts displayed on display 858. In the bypass mode, recorder 854 and a playback monitor show a darkened playback of an illegal copy, or other protection effects such as, for example, AGC gain variation or effect, brightness change, and or turning off (for a compliant device) the recording/viewing process.

However, if the bypass mode is not used, the circumvention device's input 862 is coupled to a video source (via processor circuit 850) with the new (content or Type RP) protection signal(s).

The output of circumvention device 852 then outputs a video signal with a (content or Type RP) protection signal, which in turn causes recorder 854 to exhibit protection effect(s) such as darkening, AGC effect, brightness change, and or shutting down (e.g., compliant device will shut down recording or viewing), and one or more of the following problems:

A clamp error in a portion of the program video signal.

A loss of color burst in one or more active TV lines.

A loss of program video information in one or more active TV lines.

A color unlocking or color distortion in one or more active TV lines.

A new or increased playability artifact(s) when coupled to a TV display.

It follows that inserting a circumvention device actually causes more video problems than without it when the new protection signal is applied. That is, the new protection signal causes more problems for a video pirate than without the circumvention device. For example, as previously explained, the new protection signal causes the circumvention device to enhance the protection effect, thereby discouraging the making of illegal copies of video programs.

Accordingly, it is noted that one or more of the new protection processes provide resistance to circumvention device(s) (black boxes) or provide enhancement of or synergy to the protection process (or effectiveness).

It should be reiterated that the new protection signal embodiments also reduce playability problems in some monitors. For example, by shifting the copy protection signals toward the vertical sync signal, an overshoot or ringing error in the TV set's phase lock loop feedback system settles down better by the time an active field is displayed.

This better settling time in the horizontal scanning circuits of a TV set is especially applicable to (content) protection signals where there is a position and or pulse-width modulation in the pseudo sync or AGC pulses from one TV line to another, or where the number of pseudo sync or AGC pulses changes from one TV line to another.

Correspondingly, a better settling time in a horizontal display or scanning system provides improved playability of the copy protection signal.

Thus, a prior art waveform (e.g., for PAL or NTSC) that is shifted or moved (e.g., advanced) toward the vertical sync signal, provides better playability. For example, copy protection signals, such as pseudo sync and or AGC pulses that are provided further away from the active field provide less noticeable hooking or tearing at the top of a display screen or in a portion of the overscan area.

For example, in a 625 line standard, a prior art protection signal has a Format A that has seven pulse pairs (pseudo sync/AGC) on line 8 (and or lines 10, 12, 14, 16), which is then followed by Format B that has six pulse pairs on line 9 (and or lines 11, 13, 15). An example of Format A is 1.63 microseconds (+/−100 ns) wide for pseudo sync and 7 pseudo sync pulses per line, and or Format B is 1.78 microseconds (+/−100 ns) for pseudo sync and 6 pseudo sync pulses per line, or vice versa. Other numbers or values can be provided. This prior art signal then does not have resistance to certain black boxes and or can be improved in playability.

Thus to provide resistance to or defeat of a circumvention or black box device and or to provide improved playability, one or more embodiments include(s) shifting either (or both) formats A and/or B one or two lines toward the vertical sync signal such as:
1) Format A starting on line 6 (or 318) and/or line 7 (or 319)
2) Format B starting on line 6 (or 318) and/or line 7 (or 319)

Other alternative embodiments include:

Adding/inserting/synthesizing a Format A or Format B protection signal (e.g., starting) on lines 6, 7 and/or 8 and/or lines 318 and/or 319. In one example in a 625 line standard system, lines 6, 8, 10, 12, and or 14 (and/or 16) may be of Format A (or B), while lines 7, 9, 11, 13, and or 15 may be of Format B (or A). Format A represents a set of pseudo sync and or AGC pulses and Format B represents another set of pseudo sync and or AGC pulses.

Note that in general, any type of Format A and/or Format B signals may be provided in one or more selected TV lines, provided with a selected number of pulses (e.g., pseudo sync and or AGC) per line, or provided with selected pulse width, pulse amplitude, and/or pulse position, for any of the added pulses (or sync pulse(s)). In certain cases Format A equals Format B, for example, for two or more consecutive lines. A protection process including two or more consecutive lines of (substantially) the same format toward the active field comprises an embodiment which improves playability or still causes a problem for circumvention devices. For example, a protection process can start right after or be delayed less than 2.5 lines after the vertical sync signal, with two formats interweaving/interlacing from one line to another. However, the last two or more lines that include pseudo syncs or protection signals may be a single format. Also, there is no limitation on how many formats can be provided (e.g., one or more formats).

One example (e.g., for improved playability) provides/includes one or more (e.g., 4, 5, 6, or 7) pseudo sync or pseudo sync AGC pulses in three or more TV lines with at least one series of alternating formats in two (or more) lines (e.g., in consecutive lines), while providing two consecutive lines with substantially the same format. For example, a series of TV lines may include A′A′B′, B′A′A′, A′B′A′B′B′, A′A′B′A′B′, etc., where A′ and B′ each denote a particular format. In general, each format includes a particular number of pseudo sync and or AGC pulses per line, and or includes particular pseudo sync and or AGC pulse width and or position. U.S. Pat. No. 6,836,549 by Quan and Brill issued on Dec. 28, 2004, incorporated by reference, describes various methods and apparatuses for modulating pulses in position, pulse width, and or amplitude of sync/pseudo sync and or AGC pulses, or changing the number of protection signals from one line to another, or gap-width modulation. Any example may include one or more of the various methods or apparatuses as described above for U.S. Pat. No. 6,836,549.

In any of the processes/embodiments mentioned (e.g., protection signals that provide resistance to circumvention and or improved playability), one or more of the following may be provided/generated/inserted/added to illustrate a further method and or apparatus combination.

1) Modulating any of the protection pulses such as, for example, pseudo sync and or AGC pulses, by amplitude (e.g., may include a finite value and or zero amplitude), pulse width, position, and or frequency (e.g., including changing a number of negative or positive going pulses from one video line to another line). Or providing at least one number (e.g., two or more different numbers) of pseudo sync and or AGC pulses per TV line interval in selected (e.g., two or more) TV lines.

2) Changing or shifting a portion of a video signal from one video line to another line such as, for example, lowering or raising a blanking or black level from one line to another line, or from one set of lines to another set of lines. U.S. Pat. No. 5,583,936 to Wonfor et al. issued Dec. 10, 1996 and its divisional and continuation patents, incorporated by reference, describe modifying a basic protection signal (e.g., AGC pulses and or pseudo sync/AGC pulses) with level shifting a portion of the video signal, including a portion of the active video signal and or a portion of one or more blanking intervals, for example, a portion of front and or back porch region.

3) Adding or providing a color burst modification of at least a portion of one or more color burst envelopes. The modification may include phase, frequency, and or amplitude of one or more cycles of subcarrier, or may include adding cycles of subcarrier (e.g., widened (modified or unmodified) color burst envelope) or a reduced duration color burst envelope (modified or unmodified). One or more color burst modification is shown in U.S. Pat. No. 6,516,132 to Wrobleski and Quan issued Feb. 4, 2003, incorporated by reference, and/or U.S. Pat. No. 7,039,294 to Quan issued May 2, 2006, incorporated by reference. An example comprises segmentation of one or more color burst envelopes with two or more phases (e.g., normal and non-normal phase), and/or addition of extra cycles of subcarrier in one or more horizontal blanking intervals, which can provide an extended (modified) color burst. Also sync position and or width may be altered.

4) Combining content control or protection signal(s) (e.g., back porch pulses, AGC pulses, data, CGMS, flag signal, and or pseudo sync pulses) with other TV standards such as progressive (e.g., 240p, 480p, and or 576p), HDTV, and or low definition TV. Flag signals, data signals, and or protection signals for detection or use in a content control device/system is described in U.S. Pat. No. 5,315,448 to Ryan, issued May 24, 1994 and incorporated by reference.

5) Providing dynamic blanking or modification of a video signal (e.g., one or more active field video line or one or more color burst in an active field) via coupling to a circumvention device by changing or modifying/modulating negative going pulses in a portion of the vertical blanking interval. For example, if negative going pulses near the vertical sync signal are provided or removed (or changed in position, amplitude, or width) as a function of time, the circumvention device will blank a portion of active field video lines (and or pass through one or more protection signal) when the negative pulses are provided, and then not blank a portion of active field video lines (while reducing an effect of the protection signal(s)) when the negative pulses are not provided. An illustration of providing a dynamic protection signal or effect via a circumvention device would be to alternate/switch in time prior art signals of FIG. 8A or 8B and signals of FIG. 9A or 9B. The output of the circumvention device will then generate a newly provided amplitude modulated (effect) of copy protection signals by modulating (in one to three lines) negative going pulses after a vertical sync signal.

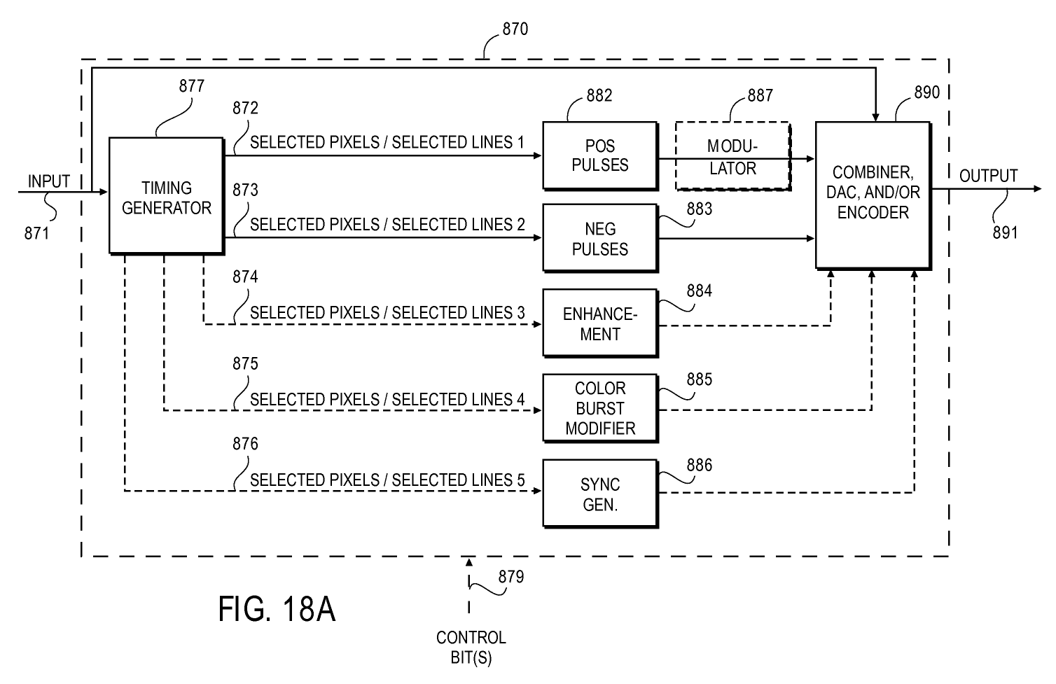

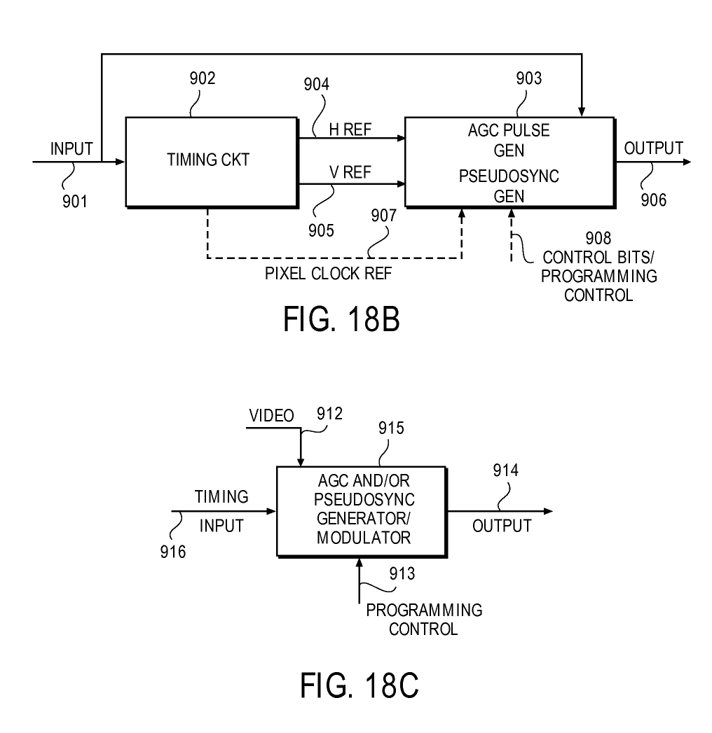

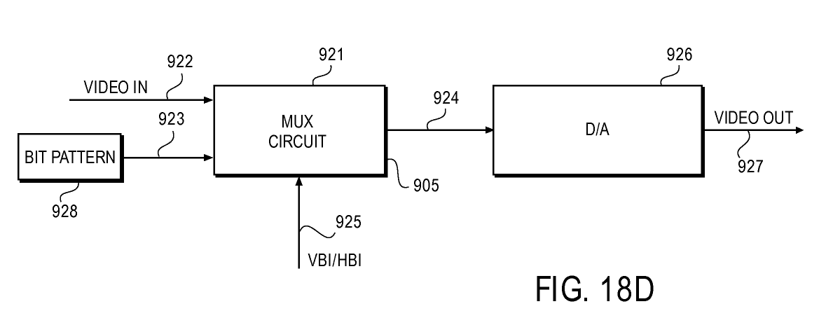

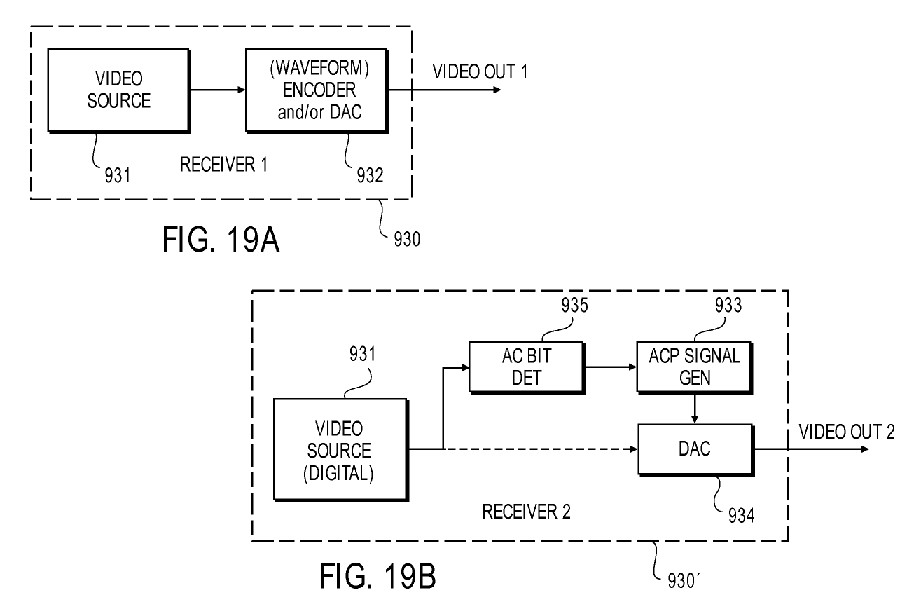

FIGS. 18A through 18D illustrate example apparatuses or systems for implementing in combination with an integrated circuit the various waveforms of description herein, in accordance with the invention.

In FIG. 18A, video (analog or digital) is supplied or coupled to an input 871. A timing generator circuit 877 receives the video signal via input 871, and produces one or more various timing signals for selected pixels/selected video lines such as provided on leads 872, 873, 874, 875, and or 876.

For example, lead 872 produces a timing signal for providing positive going pulses such as AGC pulses in selected video (TV) lines and selected pixels. The timing signal on lead 872, for instance (in the VBI) can provide a logic high signal for selected pixels on (any combination of) TV lines 317 (or 6), 318 (or 7), and or up to 327 (16) for a 625 line TV standard system. This signal, when coupled to a positive pulse generator 882, provides AGC or positive going pulses to a video output 891 of a combiner, DAC and or encoder circuit 890. Similarly, for a 525 TV line standard system, the video line allocation may include any combination of video lines from 10-20 and/or 272-283. Any of the positive going (e.g., AGC) pulses may be modulated in position, amplitude, and or pulse-width (e.g., within an interval or from one TV line to another) via an optional modulator circuit 887 (shown in dashed line).

For the positive going pulses, lead 872 may include providing an AGC or positive going pulse in a portion of the back porch, or a portion of a horizontal blanking interval, of selected TV lines (e.g., providing back porch pulses). For example, the selected lines may include one or more TV lines in an overscan area, such as a bottom of the TV field, a portion of the VBI, and or a top of the TV field. These back porch pulses may be modulated in position, amplitude, and or pulse width from one TV line to another via the optional modulator circuit 887. Also, amplitude modulation may be applied to one or more of the back porch pulses.

A signal for selected TV lines and pixels, for providing negative going pulses for one or more embodiments, is supplied on a signal lead 873 that is coupled to a negative pulse generator 883. Generally, in the VBI, the negative going pulses may include the allocation of TV lines mentioned for signal lead 872 above. It should be noted that signal leads 872 and or 873 (via setting the selected pixels) can provide a different number of pulses, positive and or negative going pulses, a position change, and or a pulse width change. For example, the signals can provide position modulation and or pulse width modulation of pseudo sync and or AGC pulses, from one TV line to another (e.g., in the VBI) for a video output such as on output terminal/connection 891.

Other features may be included in the negative going pulses or pseudo sync pulses that provide a protection signal resistant to certain black boxes. For example, an enhancement signal may be added. To this end, a selected line and or pixel signal lead 874, may provide an enhancement circuit 884 with an increased or modified protection effect via the circuit 890 and output 891. In one example, signal lead 874 provides selected lines and pixels to lower or to level shift (e.g., level shift up or down) at least a portion of the active video signal, and or to level shift at least a portion of the front and or back porch region. For example, by level shifting down a portion of one or more TV line(s) lower than a black level or a blanking level compared to another portion of the TV signal, the protection effect or protection signal is modified or enhanced. In one enhancement example, one or more portions of one or more active field line(s) is shifted or lowered in black or blanking level compared to the blanking or black level of one or more TV lines in a portion of the VBI.

Another signal modification that may be included with the various embodiments mentioned, that provide content control or protection and or resistance to certain black boxes, is the color burst phase or amplitude modification for selected TV lines. This color burst modification may include segmentation of phases and or amplitudes for providing a modified color burst in one or more horizontal blanking interval(s). Thus, the timing generator 877 provides a signal on signal lead 875 that allows selected lines and pixels to be modified such that a modified color burst is synthesized via a color burst modifier circuit 885 and combiner, DAC and or encoder circuit 890. Circuit 885 receives a signal on lead 875 to generate a modified color burst for selected lines and portion of the horizontal blanking interval (HBI). The output of circuit 885 may include an analog signal or digital signal.

For example, if the input 871 is analog, the output of circuit 885 may include a color subcarrier generator, which provides a PAL or NTSC modified color burst on selected TV lines and generally normal color burst on another set of TV lines. Should input 871 include a digital signal, circuit 885 may output digital signals to a digital color (subcarrier) encoder (not shown) such as one that would be included in circuit 890, to provide a color burst signal at output 891 that is modified for one set of TV lines and substantially normal color burst on another set of TV lines. The digital color (subcarrier) encoder may provide component video signals (e.g., R-Y, B-Y, I, or Q signals), which are modified in selected TV lines and pixels (e.g., in an HBI portion) to a color subcarrier encoder. The encoder encodes a modified PAL and or NTSC color burst signal such as, for example, color stripe, split burst color stripe, segmented phase/amplitude color burst signal, widened or narrowed color burst or color stripe envelope, and or advanced or delayed color burst or color stripe signal.

Yet another signal modification that may be included with the one or more embodiments mentioned, that provides content control or protection and or resistance to certain black boxes, is sync amplitude, position, pulse width or level shift modification for selected TV lines. A signal lead 876 provides a logic signal for selected lines and pixels to generate sync pulses of selected amplitude, position, level shifting, and or pulse-width via a sync generator circuit 886. In some instances, the protection or protection effect may be increased in effectiveness or modified via sync amplitude reduction and or sync width reduction on one or more TV lines. The output of circuit 886 is then coupled to the circuit 890 to provide a TV signal with one or more modified horizontal and or vertical sync pulse/signal.

Shown in dotted lines in the system 870, is (optionally) an input of one or more control bit(s) or bit pattern on a lead 879 that allows turning the system on or off. For example, the input on lead 879 may provide one or more waveforms such as a negative going pulse, a positive going pulse, an enhancement or modification signal (level shifting one or more portions of a video signal), color burst modification, and or sync modification, or may provide configuring/enabling/disabling the negative and or positive going pulses, or may configure/program/enable/disable an enhancement signal, color burst signal, and or sync signals.

FIG. 18B illustrates another apparatus, which receives an analog or digital signal at input 901. The input 901 is coupled to a timing circuit 902, which outputs horizontal and vertical reference signals 904 and 905 respectively. These reference signals 904 and 905 are then coupled to a pseudo sync pulse generator and AGC pulse generator circuit 903. The timing circuit 902 may also provide a pixel clock reference 907 to the circuit 903. The reference timing signals and also the input signal are coupled to circuit 903 which then provides a video signal with pseudo sync pulses and or AGC pulses at an output 906 that causes certain black boxes to pass at least some of the pseudo sync or pseudo sync and AGC pulses. By causing the black box to pass at least some of the protection pulses, an effective protection or content control signal is provided at the output of the certain black boxes, which is contrary to the design goal or intent of the black box or circumvention device. Circuit 903 may include control or programming from one or more control or programming signals or bit(s) or bit pattern(s) as depicted at an input 908. For example, in response to a control signal, control bit, or bit pattern 908, the line location, pulse width, pulse position, and or amplitude of pseudo sync and or AGC pulses may be set as by one or more bit pattern(s). A control signal or control bit may enable/disable and or program any of the waveforms and or any other waveform (e.g., enhancement signal, color burst modification, sync modification, etc.) that may be combined with, for example, the integrated circuit (as in a receiving device) in accordance with an embodiment (e.g., of the invention).

FIG. 18C illustrates a processor (circuit) 915 supplied with an input video signal on line 912 (analog or digital) and a timing signal on a line 916. Processor 915 includes a generator and or modulator. The modulator may modulate pulse width, pulse position, gap width such as between a negative going pulse and a positive going pulse, and or may modulate the amplitude of AGC pulses and or sync/pseudo sync pulses. For example, with the pseudo sync/AGC line locations of previous description, that cause a black box to become ineffective, the pseudo sync and or AGC pulses may be position or pulse width modulated within a video line or from one video line to another. The protection pulses such as AGC pulses may include amplitude modulation. An example output of processor 915 is a signal on output 914, which may include a static or dynamically modulated protection waveform(s), which defeats or reduces one or more effects of a black box, provides resistance to certain black boxes and or which improves on playability. Processor 915 may (also) include an enabling, disabling, and or programming control bit or signal on an input 913 such as previously mentioned for example in FIG. 18A and or FIG. 18B.

FIG. 18D illustrates an apparatus for use in the digital domain. A digital video signal is coupled to an input 922 of a switching or multiplex (MUX) circuit 921. Another input 923 supplies a bit pattern signal from a bit pattern generator 928, which provides digital words or bytes (or a bit pattern) that switch in various levels to provide negative going and or positive going pulses at an output 927 of a digital to analog converter 926. The circuit 921 also is supplied with a switch or multiplex control signal on an input 925, which is enabled during one or more portions of the VBI and or HBI. For example, during a portion of the VBI, such as immediately after (or up to one line delayed after) a vertical sync signal or equalizing pulse, the bit pattern generator 928 is switched in by the control input 925. Generator/source 928 provides a digital signal such that when circuit 921 is coupled to the digital to analog converter (D/A) 926, pseudo sync and or AGC pulses are provided to the video signal on input 922 with one or more pseudo sync pulses and or AGC pulses from zero to about 1.5 TV line(s) after a post equalizing pulse or after a vertical sync signal, wherein the vertical sync signal includes pre-equalizing syncs, broad sync pulses, and post equalizing syncs. When a portion of the HBI is enabled or turned active, generator 928 can provide a bit pattern which provides an AGC pulse (and/or negative going pulse) in a portion of the back porch or RBI of selected TV lines on the video output 927.

A summary of the (content or Type RP) protection signals and the integrated circuitry of previous and following description is as follows:
1) A method of providing a video protection signal to a video signal to form a protected video signal which causes a circumvention device to pass at least some of the video protection signal at the output of the circumvention device. The method includes inserting or adding, in at least one TV line, one or more pseudo sync pulses, or one or more pseudo sync pulse/AGC pulse pair signals immediately after a vertical sync signal, or delayed one line or delayed less than 2 or 2.5 lines after a vertical sync signal or post equalizing pulse. It follows that the protected video signal is substantially effective in providing protection or content control after passing through the circumvention device, contrary to the intended function of the circumvention device.
2) Wherein at least one TV line with one or more pseudo sync pulse and or AGC pulse, includes up to 18 TV lines including one or more pseudo sync pulse and or AGC pulse per TV line, or wherein the number of pseudo sync and or AGC pulses changes from one TV line to another TV line.
3) Wherein the copy protected video signal is a composite, component, PAL, NTSC or SECAM copy protected video signal, or wherein horizontal sync(s), pseudo sync(s), and or AGC signal(s) are position, pulse width, and or amplitude modulated from one TV line to another TV line, or within a TV line.
4) Wherein the circumvention device adds or enhances protection effectiveness after processing the protected signal.
5) Wherein the circumvention device further blanks a portion of the active video field.
6) Wherein the circumvention device further blanks out color burst signals in one or more TV lines in the active TV field.
7) Wherein one or more TV lines in the active TV field exhibit color distortion via the circumvention device.
8) Wherein the protected signal includes improved playability over a copy protected video signal which inserts pseudo sync pulses two or more lines after the vertical sync signal.
9) An apparatus for providing a (Type RP) video protection signal to a video signal to form a (Type RP) protected video signal which causes a circumvention device to pass at least some of the (Type RP) video protection signal at the output of the circumvention device. The apparatus includes a processing circuit receiving a video signal, for inserting or adding one or more pseudo sync pulses or pseudo sync/AGC pulse pair signals in at least one TV line immediately after, or one line or less than 2 or 2.5 lines after, a vertical sync signal or post equalizing pulse, to provide the (Type RP) protected video signal.

As mentioned previously, the invention involves providing a protection signal in combination with an integrated circuit (as in a receiver), and including pseudo sync and AGC pulses for a pulse pair signal, wherein a location of the pseudo sync pulses provides resistance to a circumvention device, wherein the circumvention device passes at least one pulse pair signal, and wherein the location of pseudo sync signals start immediately after or less than 2 or 2.5 lines after a vertical sync signal or post equalizing pulse. The combination includes one or more of the following: a color burst modification of whole or segmented sections of one or more color burst envelope which includes one or more cycles of incorrect color burst, level shifting a portion of the video signal including lowering or raising one or more portions of the video signal, modifying sync location, amplitude, and or pulse width at selected TV lines, providing back porch pulses of different video levels from one TV line to another, providing pseudo sync and or AGC pulses of different pulse widths from one TV line to another, providing pseudo sync and or AGC pulses of different numbers from one TV line to another.

Thus, an integrated circuit in combination with the protection signals of previous description, causes a circumvention device to modify the video signal so as to increase protection effectiveness while passing at least part of the protection signal to maintain copy protection effectiveness from the protection signal. The increased effectiveness provided by the circumvention device includes modifying one or more color burst signals to cause new color distortion, and or blanking/modifying a portion of the visible view area, by starting the (Type RP or content) protection signals immediately after or less than 2 or 2.5 lines after a vertical sync signal or post equalizing pulse.

In terms of chroma effects, an embodiment of the invention includes increasing color protection effects of a protection signal provided by a circumvention device, wherein the protection signal includes color burst modification in selected TV lines, and wherein the color burst modification causes a recorder or TV set to produce color distortion. This process includes combining pseudo sync and or pseudo sync and or AGC pulses immediately after or less than 2 or 2.5 lines after a vertical sync signal or post equalizing pulse with the color burst modification. The color burst modification includes cycles of incorrect phase or frequency in selected TV lines, wherein the circumvention device outputs a protection signal which produces color distortions of the modified color burst in the protection signal and extra color distortion due to blanking or modifying color burst envelopes in an active field caused by the circumvention device. For example, the circumvention device senses the pseudo sync signals to cause incorrect blanking or modification of the protection signal, which may include passing some or all of the pseudo sync and or AGC signals to the output of the circumvention device.

Circuitry for any of the above embodiments, methods, and or apparatuses may be included in an integrated circuit or part of an integrated circuit, as in the receiver. Ergo, media players, tuners, receivers, optical storage players or recorders, hard drive or magnetic storage players or recorders, solid state memory recorders or players, receivers, recorders, cell phones, TV sets, etc. may include the integrated circuit or circuitry to provide at least a part of any of the waveforms or embodiments of previous description herein. Such waveforms or embodiments, when utilized in an integrated circuit in accordance with the present invention, provide resistance to certain circumvention devices and or improve signal playability. For example, playability is improved over prior art protection signals in terms of less hooking or via less scanning error in a TV display.

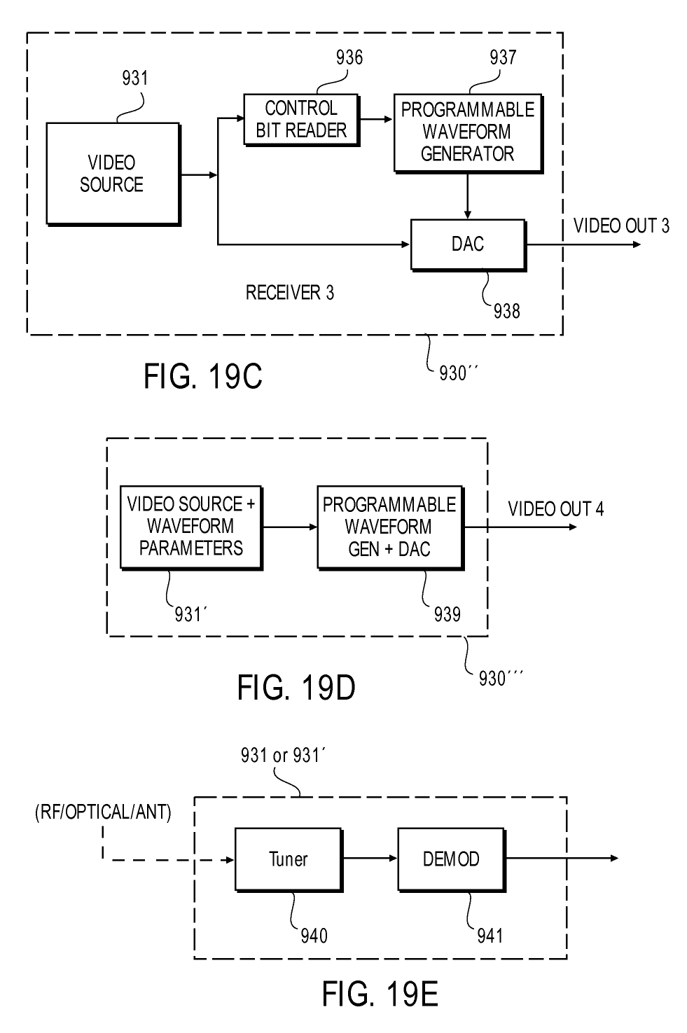

To this end, FIG. 19A illustrates a receiver 930 with a video source 931, and including an encoding and or digital to analog converter (DAC) 932. A receiver may include a set top box, TV set, mobile TV device, cell phone, and or the like. The receiver 930 provides a video output with one or more of the waveforms (e.g., the protection signals) previously described herein which provide resistance to a circumvention device, provide enhanced protection, or provide improved playability in a protected video signal. The video source 931 may be video programming or a video program from a digital delivery network, Internet, LAN, WiFi, wireless, WiMax, and or a system operator. The video source may provide a digital video signal, RF (video) signal, and or a composite, component, or S video signal. The encoder and or DAC 932 is coupled to the video source 931 and typically provides a video signal (Video out 1) with one or more of the waveforms previously mentioned, to provide a copy protected video signal. This (content or Type RP) protected video signal may be “on” by default (e.g., any of the inventive protection signals can be provided to the output of the media player upon applying power) or turned on by one or more control bits within the video source 931 or from internal or external signal(s).

Control bit(s) may select one or more waveforms or video signal modifications for the Video out 1. For instance, in the field 2 of a 525 line system, one or more pseudo sync pulse may be inserted or added in video line 9 (e.g., FIGS. 19A, 19B, 19C, and or 19D) to cause a circumvention device to pass the protection signals to the output thereof and or to cause the circumvention device to attenuate (and or level shift) a number (e.g., >=1) of active or viewable video line(s), to provide an enhanced protection effect.

FIG. 19B illustrates a receiver 930′ that includes a protection bit detector, such as an AC bit detector 935. Here the AC bit detector 935 reads or senses a digital bit stream from the video source 931. For example, upon sensing one or more bit(s), the output of video source 931 sends a command or signal via the bit detector 935 to a (Type RP or content control) signal generator 933 to provide one or more signals, or video signal modifications as previously mentioned, to a DAC (digital to analog converter) 934. The DAC 934 outputs a protected video signal (Video out 2), which provides resistance to a circumvention device, enhances a protection effect via the circumvention device, and or provides improved playability of the protected video signal. Note that DAC 934 may be coupled to the video source 931, as depicted in dashed line.

FIG. 19C illustrates an expanded example 930″ of the receiver of FIG. 19B. Here a more flexible programmability of the protected video signal is provided. The video source 931 is coupled to a control bit(s) reader/sensing circuit 936, which provides typically one or more signals to program various parameters of the protected video signal. The circuit 936 is coupled to a programmable waveform generator 937 which provides the flexibility to program one or more copy protected video signals. The output of generator 937 is coupled to an encoding and or DAC 938. Also the DAC 938 may be coupled to the video source (e.g., playback mechanism or media reader). The output of DAC 938 (Video out 3) then provides a protected waveform with programmability to provide resistance to a circumvention device, enhance a protected video signal via the circumvention device, and or provide improved playability of the protected video signal.

Programmability for example via the waveform generator 937 may include using a bit pattern or one or more APS bits to implement a Type-n signal. For instance, a Type 1 signal may include pseudo sync pulses in selected TV lines that cause a circumvention device to fail fully or partially. Alternatively, a Type 1 signal may cause a circumvention device to further enhance a protected signal by altering portions of the video signal, such as by attenuating, blanking, and or level shifting TV line(s) associated with an active field. A Type 1 signal may include sync reduction in selected TV lines, lowered front porch level in selected lines, and or lower back porch level in selected lines. In terms of modification to pixels or portions of the active line, an embodiment of the invention may include a setup level or pedestal (e.g., 7.5 IRE in a 525 line system) in the range of 1-25 IRE for one set of TV lines. Another set of TV lines (e.g., at least one line prior to a vertical sync signal or pre equalizing pulse) does not include a set up level or pedestal (e.g., around blanking level or below blanking level).

A Type 2 (protected video) signal may include a Type 1 signal with a first type of color burst modification (e.g., partial, full or split burst color stripe signal). Or a Type 3 signal may include a second type of color burst modification signal along with a Type 1 signal.

Programmability, for example, via the waveform generator 937, may include line assignment of the pseudo sync pulses, number of pseudo sync pulses per line, position of pseudo sync pulses, and or width of pseudo sync pulses. Programmability may include a negative or positive voltage level to be assigned selected lines for front and or back porch region(s). U.S. Pat. Nos. 5,583,936 ('936) and 7,050,698 ('698) relate to adding or inserting a lowering signal in the front and or back porch area. Both patents are incorporated by reference.

Lowering and or raising levels in one or more selected portion of the video signal outside a horizontal blanking interval may be part of a programming capability (e.g., of a waveform generator or biasing circuit). For example, a portion (blanking level, front or back porch) of the VBI (vertical blanking interval) may be raised or lowered with respect of one or more lines outside the VBI. (or vice versa).

For a color burst modification, programmability may include line assignment for the modified color burst and or unmodified color burst, phase angle, zone(s) of correct or incorrect phase, and or duration of one or more zones. Such variation of a color burst is disclosed in U.S. Pat. No. 6,516,132 ('132) and or 7,039,294 ('294). Both of these patents are incorporated by reference.

FIG. 19D illustrates another receiving device 930′. Here, a video source 931′ is coupled to a programmable waveform generator and DAC 939, and includes information (bit or bits) which allows programming the (Type RP or content) protected waveform. The video source 931′ thus may include solid state, optical, and or magnetic memory, which contain programming information (or actual waveform(s)) for instance to provide flexible implementation of the protected waveform, which can change from one recorded media version to another. For example, not only will the copy protected waveforms from the programmable waveform generator/DAC 939 provide resistance to circumvention devices, enhance (content) protection, and or improve playability, the (content) protected waveform(s) may be updated to a new waveform to further improve content control or copy protection effectiveness on a VCR (or a digital recorder or personal video recorder, PVR) and or to improve resistance to a circumvention device, or to provide further improved playability. U.S. Patent Publication Nos. 2006/0085863 and 2006/0083373 describe examples of programmability of protection signals from the media or external sources. For example, for a media player and or receiver, updating its protection signal(s), and or modification to the video signal, is provided via any combination of media, memory device, storage device, Internet, digital network, computer, etc. Both applications are incorporated by reference.

FIG. 19E illustrates an example of a video source or part of a receiver that has a signal source such as an antenna, RF source, and or optical link that is coupled to an input of a tuner 940. The output of the tuner 940 is coupled to a demodulator (DEMOD) 941. Typical demodulators 941 may include a circuit for I and or Q demodulation, phase demodulation, amplitude demodulation, frequency demodulation, and or pulse code demodulation. The block 931 or 931′ may include a decompression system for MPEG-x, H.26×, advanced video coding (AVC), wavelet, DCT, DFT, motion JPEG, motion GIF, and or the like. The output of demodulator 941 is typically a digital video signal but may include an analog video output).

In any of the receiving devices of FIGS. 19A-19E, changes to the (content or Type RP) protection waveform may be implemented by an internal or external signal source, such as a link to a transmission site or a “smart card,” memory circuit or similar device.

U.S. Pat. Nos. 6,381,747 and 7,395,545, which describe a receiving system pertaining to providing signal modifications for video protection or content control, are incorporated by reference.

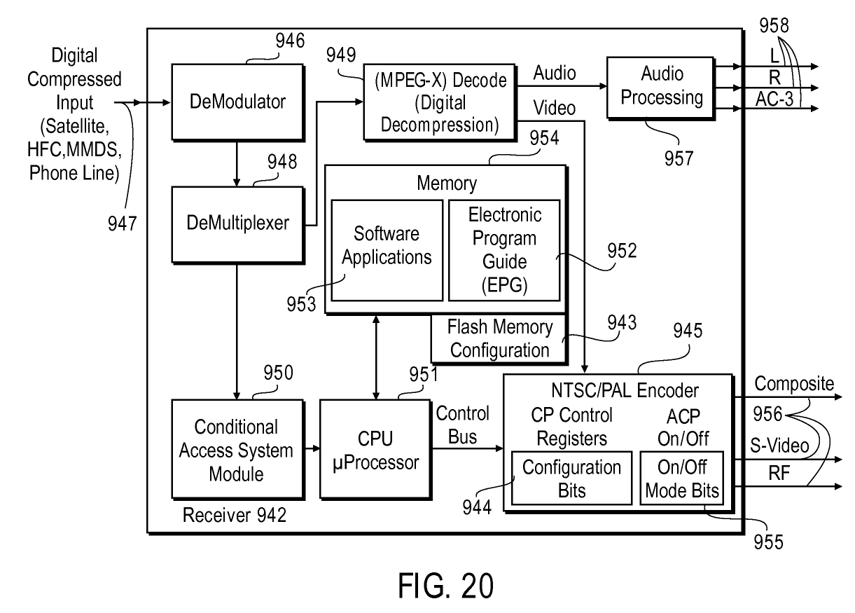

Referring to FIG. 20, there is illustrated in further detail an architecture of a set-top box(es) or receiver 942. Upon power up of the set-top box 942, the configuration bits stored in flash memory 943 are read and written into the appropriate CP (e.g., content protection) control registers 944 in a NTSC/PAL encoder 945. When the compressed digital video signal, including the protection control commands of previous and following discussion, are supplied by the delivery network of previous mention (satellite, HFC, MMDS, phone line) to a demodulator circuit 946, as depicted by an input lead 947. The demodulated video/audio and control signals are supplied to a demultiplexer circuit 948 where the video/audio signals are separated into respective channels and supplied to an MPEG-2 decoder and digital decompression circuit 949. The (content or Type RP) protection control commands are supplied from the demultiplexer 948 to a conditional access system module 950. The commands are supplied to a microprocessor in a CPU 951. The CPU processes information located in memory that is associated with the Electronic Program Guide (EPG) 952 or runs the (content or Type RP) protection application software 953 residing in memory 954 to deliver the activation command to the NTSC/PAL encoder 945. The EPG may also have data which is used to determine if (content or Type RP) protection should be activated. There are additional methods that may be employed to activate (content or Type RP) protection.

In response to the control commands, the CPU 951 supplies control signals to the NTSC/PAL encoder IC 945 of previous mention. The encoder IC 945 includes (content or Type RP) protection control registers 955, 944 for receiving the mode bits and configuration control bits respectively, of previous and following discussion. The configuration bits 944 determine the form of the (content or Type RP) protection (e.g., where the pseudo sync and AGC pulses will be located or positions of the colorstripe lines etc.) The on/off/mode byte 955 determines which components of the (content or Type RP) protection process will be activated. See table 1 below. The encoder IC 945 also receives decompressed video from the MPEG-2 decoder and digital decompression circuit 949. Encoder IC 945 outputs a RF signal, a composite video signal and/or an S-video signal via video leads 956. The decompressed audio signal is supplied from the circuit 949 to an audio processing circuit 957 which, in turn, outputs left and right channel stereo signals and/or an AC-3 signal on audio leads 958.

TABLE 1
Mode Control Bit Listing
Routine On/Off and Mode Selection

| NO | On/off and mode control; 8 bits | | |
|---|---|---|---|
| NO[7] | Reserved | | CPC0[3] |
| NO[6] | Pay-to-tape allowed/prohibited | (Allowed = 1, | CPC0[2] |
| | | Default = 0) | |
| NO[5] | VBI pulses On/Off (VBIP) | (ON = 1) | CPC0[1] |
| NO[4] | End of Field Back Porch Pulses | (ON = 1) | CPC0[0] |
| | on/off (EOFP) | | |
| NO[3] | Colorstripe process On/Off (CSP) | (ON = 1) | CPC1[3] |
| NO[2] | AGC pulse normal (amplitude | (Cycling = | CPC1[2] |
| | cycling)/static mode select | Default = 1) | |
| | (AGCY) | | |
| NO[1] | H-sync amplitude reduction | (ON = 1) | CPC1[1] |
| | On/Off (HAMP) | | |
| NO[0] | V-sync amplitude reduction | (ON = 1) | CPC1[0] |
| | On/Off (VAMP) | | |

It is preferred in one or more embodiments, a process on/off control is achieved by setting all the individual parameter on/off and mode control bits rather than a master on/off control. This requires that the N0 (N-zero) bits in the control bit listing be set as required. Depending on the individual system, this will require the control of from 5 to 8 bits.

The delivery of the mode byte to the set-top box to activate or deactivate the (content or Type RP) protection process may be accomplished in several ways. Each method has its positive aspects as well as its negative aspects. When selecting a mechanism to control the (content or Type RP) protection technology, a service provider selects one of the following means or may develop an entirely new means.

One method may be for the mode byte to be delivered via the conditional access system via the entitlement control message (ECM). Another method might be to include the mode byte in a private data field in the MPEG transport data stream.

Another method may deliver the mode byte in a user defined section of the electronic program guide (EPG 952, FIG. 20) that is not identified in released documentation as controlling (content or Type RP) protection. This method also requires some additional security to keep the memory location of the mode byte from being accessed for unauthorized changes and the setting of a return flag that indicates the actual status of the mode byte when transmitted to the NTSC encoder (945).

Another method may be a combination of the conditional access ECM and EPG. The transport of the mode byte in the EPG could be combined with two bits within the ECM. To activate the (content or Type RP) protection technology then would require an OR operation between the ECM bits and the EPG bits. If either is set, the (content or Type RP) protection technology, both ECM and EPG would have to indicate that deactivation is necessary.

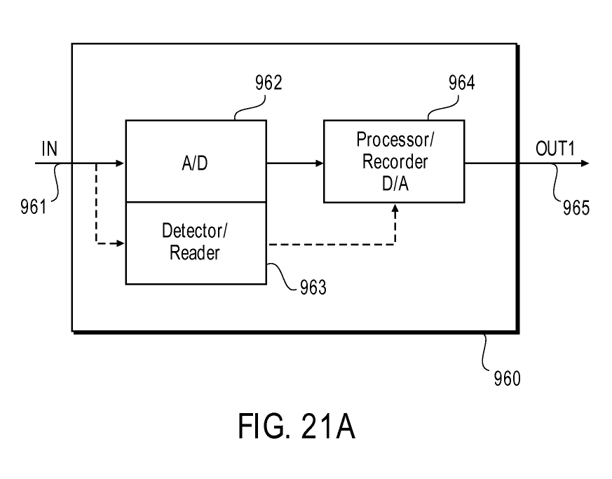

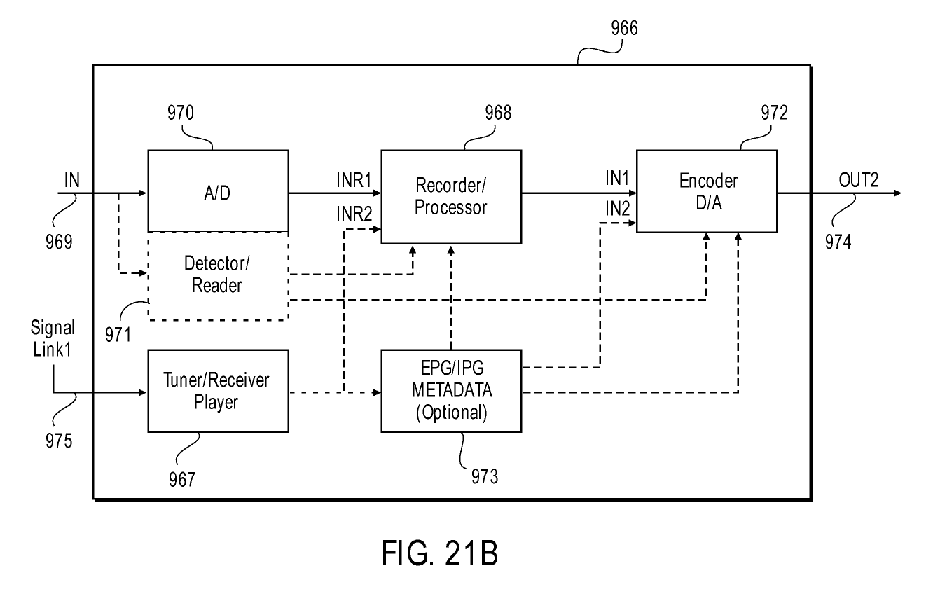

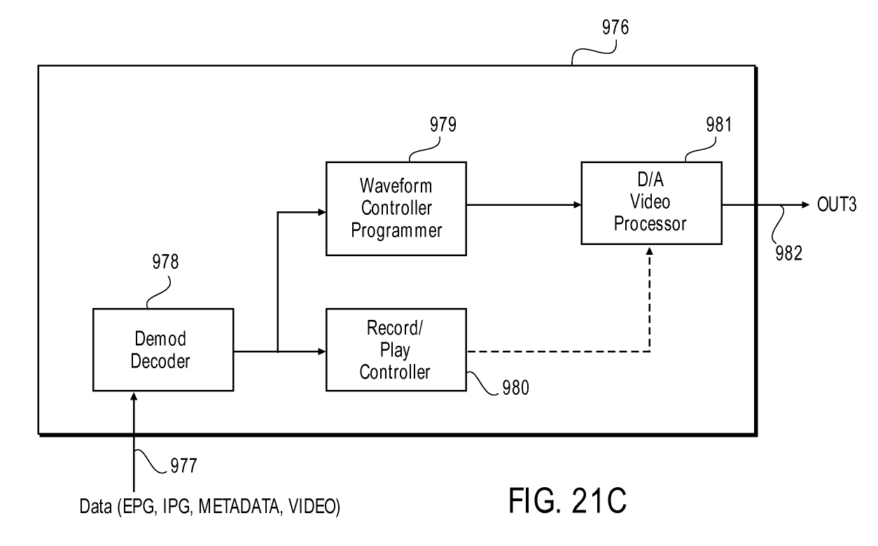

FIG. 21A illustrates an embodiment 960 of the invention for a system, integrated circuit, system on a chip (SOC), and or chip set, which includes a baseband video input 961 coupled to an analog to digital converter (ADC) 962, and a reading or detector circuit 963 for optionally sensing one or more protection signal. Thus, the sensing of the one or more protection signal may be done in the analog and or digital domain. For example, an analog signal on input 961, with one or more protection signal, may be coupled to the detector/reader 963, or may be coupled to the detector/reader 963 via a digital output of analog to digital converter 962. Detector/reader 963 senses the one or more copy protection signal and sends one or more commands to a processor/recorder 964. For example, if a certain protection signal is sensed (e.g., a pseudo sync, AGC pulse and or color burst modification), a command to shut down or limit recording may be sent to processor/recorder 964. In another example, if a protection signal is sensed, a command may be sent to processor/recorder 964 (e.g., a recorder or processing circuit) so as to output for example program video OUT1 via an output 965 with the same type of (content) protection signal, another type of (content) protection signal, a weakened copy protection signal, or effectively no copy protection signal.

Example input signals and output signals for system 960 may include:

Input comprising a video signal with a standard protection signal that is not resistant to a black box, with an output video signal with a new protection signal resistant to black boxes and or a new protection signal with improved playability.

Input comprising a video signal with a (content or Type RP) protection signal that is resistant to a black box, with an output video signal with a protection signal not resistant to black boxes, and or a new protection signal with improved playability.

Other combinations of input/output signals are possible for system 960. For example, the input can include a copy protected video signal with improved playability while the output provides a (content) protected video signal without improved playability (wherein the improved playability signal includes any of the (content) protection signals with improved playability), or vice versa.

FIG. 21B illustrates a system, integrated circuit, SOC, and or chip set denoted by numeral 966, as an example embodiment of the invention, which like FIG. 21A, also includes optionally a tuner/player device 967 and or, optionally, a system to read signals from at least a portion of metadata, Electronic Programming Guide (EPG), and or Interactive Programming Guide (LPG) for controlling a recorder 968, and or for programming/enabling/disabling a protection signal (e.g., a (content or Type RP) protection signal that provides resistance to a black box). A baseband video signal is coupled via an input 969 to an input of analog to digital convertor (A/D) 970, which optionally may include a detector or reader 971 of content control signal(s) in the baseband video input signal. By sensing signals such as pseudo sync, AGC, or Data (e.g., CGMS) pulses, or color burst modification(s), the detector/reader 971 may provide a command signal to the recorder or processor 968 to perform for example one or more of the following: allow recording/processing, prohibit recording/processing, provide an altered resolution or altered quality recording, provide copying or recording during a specific time or duration, or provide or allow a limited number of recordings. The detector/reader 971 may provide a signal to an encoder/digital to analog converter (DAC) 972 to synthesize one or more (content or Type RP) protection signals in any combination as dependent on the input signal. This may include a baseband input signal or a signal supplied via a processor 973 such as a metadata, IPG, or EPG signal. Alternatively, a default copy protection signal OUT2, such as a (content or Type RP) protection signal that is resistant to a black box, or an improved playability protection signal, may be synthesized on an output 974.

A signal link on an input 975 an RF source, a wireless source, Internet or digital delivery network, phone line, cable, fiber, optical, or satellite, may be coupled to the tuner/receiver 967. Device 967 may include a player, which plays back digital signals. An output of tuner/receiver 967 optionally may be coupled to an input of the recorder or processor 968, or to the optional EPG/IPG/metadata signal processor 973. An output of device 973 may then contain information from EPG/IPG/metadata signal(s) to control processing or recording (for example, for recorder/processor 968) or to program/enable/disable (content or Type RP) protection signal(s) provided from the encoder/DAC 972. The EPG/IPG/metadata may be transmitted or added/inserted in a baseband video signal or may be provided via a digital delivery system (e.g., from a system operator, or as a digital data signal). For example, the at least a portion of a signal including IPG/EPG/metadata, may be used to control a video processing device or recording device, or may be used for programming/enabling/disabling one or more content control signals or (content or Type RP) protection signals, and or for providing a (content) protection signal that provides resistance to a black box or provides improved playability (e.g., as mentioned in one or more embodiments or examples of the invention).

Thus FIG. 21B includes a recorder apparatus and use of EPG or IPG signals. One example for interactive (television) program guides is as follows: A method and or apparatus for transferring recorded programs (or recording programs) using an interactive (television) program guide implemented on user video or television equipment, wherein the method and or apparatus comprises any combination of displaying on a display screen at least one program listing related to at least one program; enabling a user to select a program entry from the at least one displayed program listing; recording the selected program related to the at least one displayed program listing on a digital storage device; displaying at least one recorded program listing for at least one program recorded on the digital storage device, wherein the at least one recorded program listing includes a recorded program entry for the program recorded on the digital storage device; enabling the user to select the program recorded to transfer the recorded program from the digital storage device to a secondary (or to another portion of the primary or (the) digital storage) device; transferring the recorded program from the digital storage device to a secondary storage device; enabling the user to select a sequence of programs recorded on the digital storage device; and or transferring the sequence of programs to the secondary storage device.

FIG. 21C illustrates another embodiment 976 of the invention including an integrated circuit (IC), SOC, chip set, and or system. A data signal including video, EPG, IPG, and or metadata is coupled via an input 977 to a demodulator or decoder 978. A bit pattern from at least a portion of the data signal from demodulator/decoder 978 is coupled to a waveform controller or programmer 979 to enable/disable/program any number of (content or Type RP) protection signals, and or enhancement signals, which may include a protection signal to provide resistance to a black box, and or to provide improved signal playability.

An output of demodulator/decoder 978 may be coupled to a controller 980 for recording, displaying, and or playing video programs. For example, a bit pattern from metadata, IPG, and or EPG may be used as a command to pass or block a video program signal, and or to alter video quality of the program video signal via a video processor 981. A signal OUT3 on output 982 then includes for example a video signal with a (content or Type RP) protection signal (e.g., triggered or flagged by a bit pattern from a metadata, IPG, or EPG signal via for example a digital delivery network) that provides resistance to a black box, or that provides improved playability.

A summary of one or more embodiment of the invention includes a (content or Type RP) protection signal from an integrated circuit (IC) that improves geometric distortion for better playability, a (content or Type RP) protection signal that reduces or defeats the function of a circumvention device, and or a (content or Type RP) protection signal from an integrated circuit that triggers or causes a circumvention device to enhance protection effect(s). Such (content or Type RP) protection signals may be utilized in an integrated circuit as follows:

An integrated circuit which comprises;

a digital to analog converter coupled to a source of digitally recorded material or digital video for providing a (baseband) video signal from a digital signal, a signal sensing or reader circuit for detecting or reading protection bit, a bit pattern or content control bit(s), and a signal generator for generating a (content or Type RP) protection signal at the output of the digital to analog converter in response to the protection bit, bit pattern, or content control bit(s).

One or more embodiments of the invention includes any of the following characteristics:

The protection signal is supplied via an output of the integrated circuit to an input of the circumvention device, wherein the output of the circumvention device passes at least part of the protection signal sufficiently for a protection or content control effect, and or wherein the output of the circumvention device provides a signal to further distort or blank a portion of an active TV field.

The protected video signal from the integrated circuit is coupled to an input of the circumvention device, wherein the output of the circumvention device supplies a signal that is substantially effective in terms of protection or content control for a video recorder or for a content control system.

A circuit for inserting or adding in at least one TV line one or more pseudo sync pulses or one or more pseudo sync (pulse)/AGC pulse pair signals immediately after or less than two or two and a half lines after a vertical sync signal or post equalizing pulse (e.g., in an odd field, even field, or both fields).

A method of providing a different number of pseudo sync pulses from one video line to another video line and or different pseudo sync pulse widths from one video line to another, generating at least two lines consecutively with substantially the same number of pseudo sync pulses and or substantially the same pseudo sync pulse width (e.g., for improved playability).

A (content or Type RP) protected video signal is supplied to a TV set via an output of the receiving device, wherein improved playability is achieved via reduced hooking on a top portion of the TV.

A method of starting or providing pseudo sync pulses immediately after or less than 2 or 2.5 lines after a vertical sync signal or post equalizing pulse to provide the (content or Type RP) protection signal at an output of the integrated circuit, may include one or more of the following: a color burst modification of whole or segmented portions of one or more color burst envelope which includes one or more cycle of incorrect color burst, level shifting of a portion of the video signal including lowering or raising one or more portions of the video signal, modifying sync location, amplitude, and or pulse width in selected video lines, providing back porch pulses of different video levels from one video line to another, providing pseudo sync and or AGC pulses of different pulse widths from one video line to another, providing pseudo sync and or AGC pulses of different numbers from one video line to another.

The protection signal is supplied via an output of the integrated circuit (IC) (receiver) to an input of the circumvention device, wherein the output of the circumvention device passes at least part of the protection signal sufficiently for a protection or content control effect, and or wherein the output of the circumvention device provides a signal to (further) distort or blank a portion of an active TV field.

Combining pseudo sync and or pseudo sync and automatic gain control (AGC) pulses immediately after a vertical sync signal or less than two or two and a half video lines after a vertical sync signal or post equalizing pulse, with the color burst modification (e.g. color stripe, partial color stripe), which in combination is generated at an output of the integrated circuit, wherein the color burst modification includes cycles of incorrect phase or frequency in selected video lines, wherein the baseband, composite, and or component output of the IC is coupled to an input of the circumvention device, and wherein outputting via the circumvention device a (content or Type RP) protection signal which produces color distortions in the modified color burst of the copy protection signal and extra color distortion due to blanking or modifying of color burst envelopes in an active video field caused by the circumvention device.

It should be noted that an integrated circuit by default may provide one or more protection or content control signal as previously mentioned when power is applied to the device. In another embodiment of the invention an integrated circuit may produce a partial or no protection or content control signal upon power-up, until a network signal (e.g., IPTV, WiMax, WiFi, phone, RF, TV, DTV, HDTV, optical, Internet, router signal, signal from a computer, or the like), or transmission, is received in the integrated circuit. Here for example, one or more (content or Type RP) protection or content control signal is provided (e.g., to provide a more complete or effective protection or content control signal by a video signal) upon reception of a signal by the integrated circuit.

Another embodiment of the invention includes:

An apparatus for programming or enabling or disabling a content control signal derived from a metadata, IPG, and or EPG signal comprising:
a circuit to receive a metadata, IPG, and or EPG signal from a digital delivery network wherein the metadata, IPG, and or EPG signal includes a trigger or flag signal or bit pattern signal, further comprising coupling the trigger, flag, and or bit pattern signal to a processing circuit and or an encoding circuit to provide programming, enabling, or disabling the content control signal at an output of the encoder, wherein the content control signal is added or inserted to a video signal to provide a content controlled video signal and wherein the content controlled video signal provides resistance to a circumvention device.

U.S. Pat. No. 5,479,268 (Young et al, issued Dec. 26, 1995) and US Patent Publication No. US 2003/0149980 (Hassell et al. published Aug. 7, 2003) pertain to programming guides such as EPG and IPG, and are both incorporated by reference. An example EPG (Electronic Programming Guide) or IPG (Interactive Programming Guide), which may be provided or derived via an IPG/EPG signal, comprises a method or apparatus for allowing a user to select one or more (favorite) channel that includes providing (to) a display (e.g., via a screen) a plurality of cells representing a corresponding plurality of channels available for viewing by the user, wherein each cell comprises a channel number and or a program service name for a particular channel of the plurality of channels. The user is allowed to use the display to select a channel among the plurality of channels; for example, changing a status of said selected channel to that of a favorite channel (is) in response to the user selection, or displaying in cells corresponding to the favorite channels a visual indication that the selected channels are favorite channels, and providing program guide information for the subset of channels having said favorite status in response to a user indication to view the program guide information.

Another example of an EPG or IPG (derived from an EGP or IPG signal) includes a method or apparatus for navigating about a television or video listing comprising one or more steps of: storing in (electronic) memory a plurality of television or video program listings, each listing including title, telecast time, and or channel; displaying on a monitor screen some titles of the program listings in a grid format of time and channel; moving a cursor on the screen to mark one (or more) of the displayed titles in the grid guide format; opening to the marked title in a single (or multiple) format, instead of in the (original) grid guide format, wherein the single channel format includes rows (or columns) of sequential television or video program listings for the channel corresponding to the marked title; (additionally) comprising moving the cursor on the screen to mark a different displayed title in the single channel format; any of the previous steps wherein the storing step stores programming listings, and or the displaying step displays the program notes corresponding to the marked title simultaneously with the program listings.

A grid pattern or cell may include straight or curved segments. Alternatively, a two dimensional grid pattern may be transformed to a three dimensional grid pattern or vice versa. A grid pattern may include three and or two dimensional properties. For example, one cell to another cell in the programming guide may be represented in a curved surface and or a solid object's sides. Cells may be of regular and or irregular shape(s).

A phase modulated color burst signal may be included in any embodiments of previous description. For example, a color burst that has one or more cycles of non standard phase (e.g., 20 degrees to 180 degrees from a reference color burst phase) may be included. A split burst signal comprising multiple cycles of normal and or non normal phase for one or more lines within a television field or frame is an example signal that may be included in an output of any devices that include broad band recording.

A weakened color stripe or phase modulated signal may include (within 15%) 2 cycles of normal color subcarrier phase, 6.5 cycles of non normal color subcarrier phase (e.g., 180 degrees), and or 7 cycles of normal color subcarrier phase. Alternatively, another weakened color stripe or phase modulated signal may include (within 15%) 6.5 cycles of non normal color subcarrier phase (e.g., 180 degrees), and or 8.5 cycles of normal color subcarrier phase. The weakened color stripe signal may occur in R lines per Q lines, where R and Q are from the set of integers. For example, a weaken color stripe signal may be provided in a 1, 2, 3, 4, or 5 line(s) per Q lines, where Q is greater than 1, 2, 3, 4, or 5 (and where Q is greater than R). A television color standard may be in PAL or NTSC (or a variant signal, such as a progressive or interlaced signal with color subcarrier), or in a composite, S-Video, or Y/C television signal.

This disclosure is illustrative and not limiting. For example, any of the content control signals or protection signals may be incorporated in a device that includes (e.g., any combination of) a conventional recorder, a recorder and or player that includes a broadband recording method or apparatus, a recorder that includes one or more tuners, a media player, and or a recorder including a tuner and a demodulator. Further modifications will be apparent to those skilled in the art in light of this disclosure and are intended to fall within the scope of the appended claims.

What is claimed is:

1. Apparatus for providing an interactive programming guide (IPG), and or electronic programming guide (EPG), comprising:
a receiving device including a circuit for receiving a metadata, IPG, and or EPG signal from a digital delivery network, wherein the digital delivery network provides the receiving device with a trigger, flag or bit pattern signal;
a processing circuit and or encoding circuit for providing programming, enabling, or disabling of a content control signal at an output of the processing and or encoding circuit in response to the trigger, flag, and or bit pattern signal; and
wherein the content control signal is added to or inserted in a video signal to provide a content controlled video signal which provides resistance to a circumvention device.

2. The apparatus of claim 1 wherein the IPG or EPG signal provides an IPG/EPG guide including a plurality of television program listings, each listing including title, telecast time, and or channel.

3. The apparatus of claim 2 wherein the titles of the television program listings are displayed on a monitor screen in a grid guide format of time and channel.

4. The apparatus of claim 3 further comprising:
moving a cursor on the screen to mark one of the displayed titles in the grid guide format.

5. The apparatus of claim 2 wherein the titles of the television program listings are displayed on a monitor screen in a single channel format; and
wherein a cursor is moved to mark a displayed title and to open to the marked title in the single channel format.

6. The apparatus of claim 5 wherein the single channel format includes rows or columns of sequential television program listing for the channel corresponding to the marked title.

7. The apparatus of claim 6 further comprising moving the cursor on the screen to mark a different displayed title in the single channel format.

8. The apparatus of claim 1 further comprising a recording device, wherein the IPG is utilized for transferring recorded programs or recording programs.

9. The apparatus of claim 8 wherein:
the IPG provides a display on a display screen of at least one listing related to at least one program, enabling a user to select a program entry from the at least one displayed program listing; and
a digital device for recording the selected program related to the at least one displayed program listing.

10. The apparatus of claim 1 wherein the receiving device includes any combination of; a DVD player, PVR, Blu-Ray player, recorder, media player, receiver, digital media extender device, set top box, optical storage device, solid state storage device, tuner, multiple tuner device, computer, digital camera, video camera, Internet Protocol Television device, wireless device, optical signal transmission device and or optical signal receiving device, Radio Frequency device, WiFi device, WiMax device, wireless device, RF broadband recording device, and or cell phone.

11. The apparatus of claim 1 wherein the content control signal inhibits recording of the normally displayable programming guides.

12. The apparatus of claim 1 wherein the content control signal includes at least one negative going pulse and or at least one pseudo sync pulse located in one or more television line numbered 10, 11, 272 and or 273, for a 525 line television system.

13. The apparatus of claim 12 further including at least one pseudo sync pulse in one or more television line after television lines numbered 10, 11, 272 and or 273, for a 525 line television system.

14. The apparatus of claim 1 wherein the content control is used as a copy protection signal.

15. The apparatus of claim 1 wherein the content control signal resistant to the circumvention device enhances the content control effect by causing the circumvention device to produce distortion, attenuation, and or signal replacement in one or more television line or lines that is or are displayed in an active television field.

16. The apparatus of claim 15 wherein the circumvention device hampers viewing of at least a portion of the electronic programming guide or interactive programming guide by distorting, attenuating, and or signal replacing one or more television line in the active field containing programming guide display or information.

17. A method of providing an electronic programming guide (EPG) or interactive programming guide (IPG) via a system operator or a broadcaster, comprising:
sending or distributing data or signals related to the electronic programming guide or interactive programming guide to a receiving device via a system operator or broadcaster;
sending or distributing a bit pattern or one or more control bits related to content control to the receiving device via the system operator or broadcaster;
wherein the receiving device provides a video signal for display of the electronic programming guide or interactive programming guide; and
wherein the receiving device provides the video signal with a content control signal to provide a content controlled video signal which provides resistance to a circumvention device.

18. The method of claim 17 wherein the display of the electronic programming guide or interactive programming guide provides a plurality of television program listings, each listing including title(s), telecast time(s), and or channel(s).

19. The method of claim 18 wherein the title(s) of the television program listings displayed on a monitor screen are in a grid guide format of time and channel.

20. The method of claim 19 further comprising:
moving a cursor on the screen to mark one or more of the displayed titles in the grid guide format.

21. The method of claim 18 wherein the titles of the television program listings are displayed on a monitor screen in a single channel format; and
wherein a cursor is moved to mark a displayed title and to open to the marked title in the single channel format.

22. The method of claim 21 wherein the single channel format includes rows or columns of sequential television program listings for the channel corresponding to the marked title.

23. The method of claim 22 further comprising moving the cursor on the screen to mark a different displayed title in the single channel format.

24. The method of claim 17 further comprising;
utilizing the interactive programming guide for transferring recorded programs or recording programs via a recording device.

25. The method of claim 24 further comprising:
displaying on a display screen via the interactive programming guide at least one listing related to at least one program to enable a user to select a program entry from the at least one displayed program listing; and
recording the selected program related to the at least one displayed program listing on a digital device.

26. The method of claim 17 further comprising:
utilizing as the receiving device any combination of: DVD player, PVR, Blu-Ray player, recorder, media player, receiver, digital media extender device, set top box, optical storage device, solid state storage device, tuner, multiple tuner device, computer, digital camera, video camera, Internet Protocol Television device, wireless device, optical signal transmission device and or optical signal receiving device, Radio Frequency device, WiFi device, WiMax device, wireless device, RF broadband recording device, and or cell phone.

27. The method of claim 17 wherein the content control signal inhibits recording of the displayable programming guides.

28. The method of claim 17 wherein the content control signal includes one or more negative going pulse(s) and or one or more pseudo sync pulse(s) located in one or more television line numbered 10, 11, 272 and or 273, for a 525 line television system.

29. The method of claim 17 further including one or more pseudo sync pulse(s) in one or more television line after television lines numbered 10, 11, 272 and or 273, for a 525 line television system.

30. The method of claim 17 wherein the content control is used as a copy protection signal.

31. The method of claim 17 further comprising:
enhancing the content control effect via the content control signal resistant to the circumvention device by causing the circumvention device to produce distortion, attenuation, and or signal replacement in one or more television line(s) that is, are displayed in an active television field.

32. The method of claim 31 wherein the circumvention device hampers viewing of at least a portion of the electronic programming guide or interactive programming guide by distorting, attenuating, and or replacing the signal in one or more television line in the active television field containing programming guide display or information.

33. A method of recording a video program, wherein the video program includes a video signal and an audio signal, comprising;
recording the video signal and the audio signal that is associated with the video program;
recording one or more of the following signals; data or information associated with the video program, time code and or date code signal, second audio channel, descriptive video service audio channel, channel number or identification data that is related to the video program, and or a programming guide;
wherein upon playback of the recorded video program, the recorded video and audio signals are played back with a capability of also playing back, for display or sound reproduction, one or more of the following; time code and or date code signal, second audio channel, descriptive video service audio channel, channel number or identification data that is related to the video program, and or a programming guide.

34. The method of claim 33 wherein one or more of the following signals; data or information associated with the video program, time code and or date code signal, second audio channel, descriptive video service audio channel, channel number or identification data that is related to the video program, and or a programming guide, is communicated to a cell phone, computer, digital delivery network, external device, remote control, and or display;
thereby for reproducing via a display or conversion to sound, one or more of the following during playback; a time code and or date code signal, second audio channel, descriptive video service audio channel, channel number or identification data that is related to the video program, and or a programming guide.

35. A method of playing back a recording of a video program, comprising:
playing back the recording which includes a video signal and an audio signal that is associated with the video program while playing back one or more of the following signals; data or information associated with the video program, time code and or date code signal, second audio channel, descriptive video service audio channel, channel number or identification data that is related to the video program, and or a programming guide;
wherein upon playback of the recorded video program, the recorded video and audio signals are played back with a capability of also playing back, for display or sound reproduction, one or more of the following; time code and or date code signal, second audio channel, descriptive video service audio channel, channel number or identification data that is related to the video program, and or a programming guide.

36. The method of claim 35 wherein the player reproduces one or more of the following signals; data or information associated with the video program, time code and or date code signal, second audio channel, descriptive video service audio channel, channel number or identification data that is related to the video program; and or
a programming guide is communicated via the player to one or more of the following; cell phone, computer, digital delivery network, external device, remote control, and or display, for reproducing via a display or by conversion to sound one or more of the following during playback; time code and or date code signal, second audio channel, descriptive video service audio channel, channel number or identification data that is related to the video program, and or a programming guide.

37. Apparatus for recording a video program, wherein the video program includes a video signal and an audio signal, comprising;
a recorder for recording the video signal and the audio signal that is associated with the video program and for recording one or more of the following signals; data or information associated with the video program, time code and or date code signal, second audio channel, descriptive video service audio channel, channel number or identification data that is related to the video program, and or a programming guide;
wherein upon playback of the recorded video program, the recorded video and audio signals are played back with a capability of also playing back, for display or sound reproduction, one or more of the following; time code and or date code signal, second audio channel, descriptive video service audio channel, channel number or identification data that is related to the video program, and or a programming guide.

38. Apparatus for playing back a recording of a video program, comprising:
a player for playing back the recording which includes a video signal and an audio signal that is associated with the video program while playing back one or more of the following signals; data or information associated with the video program, time code and or date code signal, second audio channel, descriptive video service audio channel, channel number or identification data that is related to the video program, and or a programming guide;
wherein upon playback of the recorded video program, the recorded video and audio signals are played back with a capability of also playing back, for display or sound reproduction, one or more of the following; time code and or date code signal, second audio channel, descriptive video service audio channel, channel number or identification data that is related to the video program, and or a programming guide.
